(19) United States
(12) Patent Application Publication
(10) Pub. No.: US 2011/0202329 A1
(43) Pub. Date: Aug. 18, 2011

(54) Scenario State Processing Systems And Methods For Operation Within A Grid Computing Environment

(76) Inventors: James Howard Goodnight, Cary, NC (US); Steve Krueger, Raleigh, NC (US); Oliver Schabenberger, Cary, NC (US); Christopher D. Bailey, Cary, NC (US)

(21) Appl. No.: 12/705,204

(22) Filed: Feb. 12, 2010

(51) Int. Cl. G06F 15/76; G06F 9/06; G06F 9/00; G06F 15/16

(52) U.S. Cl. 703/21; 712/30; 718/101; 709/250; 712/E09.003

(57) ABSTRACT

Systems and methods are provided for generating multiple system state projections for one or more scenarios using a grid computing environment. A central coordinator software component executes on a root data processor and provides commands and data to a plurality of node coordinator software components. A node coordinator software component manages threads which execute on its associated node data processor and which perform a set of matrix operations. Stochastic simulations use results of the matrix operations to generate multiple state projections. Additional processing can be performed by the grid computing environment based upon the generated state projections, such as to develop risk information for users.

### TECHNICAL FIELD

The technology described herein relates generally to distributed data processing and more specifically to scenario analysis using distributed data processing.

### SUMMARY

In accordance with the teachings provided herein, systems and methods are provided for generating multiple system state projections for one or more scenarios. For example, a central coordinator software component executes on a root data processor and provides commands and data to a plurality of node coordinator software components. Each of the node coordinator software components are associated with and execute on separate node data processors. The node data processors have volatile computer memory for access by a node coordinator software component and for access by threads executing on the node data processor. A node coordinator software component manages threads which execute on its associated node data processor and which perform a set of matrix operations with respect to the simultaneous linear equations. Stochastic simulations use results of the matrix operations to generate multiple state projections. Threads execute on their associated node data processor and perform a portion of the scenario evaluations based upon the state projections and based upon scenario information provided by a user computer, thereby generating scenario evaluation results. The volatile computer memory of a node data processor retains the results of the scenario evaluations that were performed at the node data processor.

The central coordinator software component is configured to receive ad hoc questions from the user computer and provide responses to the ad hoc questions by aggregating and concatenating the scenario evaluation results provided by each of the node data processors.

The central coordinator software component processes the ad hoc questions from the user computer by instructing the node coordinator software component to access and process the results of the scenario evaluations that are stored in the volatile memory of its associated node data processor.

### BRIEF DESCRIPTION OF THE DRAWINGS

FIG. 1 is a block diagram depicting an environment wherein users can interact with a grid computing environment.

FIGS. 2 and 3 are block diagrams depicting illustrate hardware and software components for the grid computing environment.

FIG. 4 is a process flow diagram depicting a process flow of a grid computing environment which has been configured for performing scenario state processing.

FIG. 5 is a process flow diagram illustrating a set of operations for using a central coordinator and node coordinators to generate system state projections.

FIG. 6 is a process flow diagram depicting functionality directed to using system state projections for generating scenario analysis results.

FIG. 7 is a process flow diagram depicting functionality directed to aggregating results from the node coordinators and using the results to respond to ad hoc user queries.

FIG. 8 is a process flow diagram depicting a market state generation and risk pricing application using a grid computing environment.

FIG. 9 is a table depicting two business years of information which has been collected for the risk factors for each business day.

FIG. 10 depicts additional input data for generating market state projections.

FIG. 11 is a process flow diagram depicting matrix operations and stochastic simulations that are used to generate market state projections.

FIG. 12 is a process flow diagram depicting a central coordinator distributing risk factor historical data to the node coordinators.

FIG. 13 is a process flow diagram illustrating a wave data distribution technique.

FIGS. 14 and 15 depict an example of storage of an X′X matrix.

FIG. 16 is a process flow diagram depicting functionality directed to performing row adjustments in order to construct the L′ matrix.

FIG. 17 is a process flow diagram depicting a wave technique.

FIG. 18 is a process flow diagram depicting node coordinators being provided with the L′ matrix.

FIGS. 19 and 20 are process flow diagrams depicting functionality directed to generating and distributing random vectors to the node coordinators.

FIG. 21 is a process flow diagram depicting functionality directed to computing market state projections based upon the L′ matrix.

FIG. 22 is a process flow diagram depicting node coordinators generating a subset of the overall request of the market state projections.

FIG. 23 depicts an example of market state projection results.

FIG. 24 is a process flow diagram depicting node processors using the market state projections to generate position pricing results.

FIG. 25 depicts input position data.

FIG. 26 is a process flow diagram depicting threads generating different position pricing results.

FIG. 27 is a process flow diagram depicting a mechanism for distributing positions provided by a user to the nodes.

FIG. 28 is a process flow diagram depicting a first position being distributed among the node coordinators.

FIGS. 29-31 are process flow diagrams depicting pricing functions being used by the nodes.

FIG. 32 depicts an example of position pricing results.

FIGS. 33 and 34 depict an example of node coordinators storing pricing results.

FIG. 35 is a process flow diagram depicting the information at the node coordinators being retained in memory throughout the multiple steps to the extent that it is needed to provide answers at different levels to the user.

FIG. 36 is a process flow diagram depicting functionality directed to aggregating results from the node coordinators and using the results to respond to ad hoc user queries.

FIG. 37 is a process flow diagram depicting an array of price positions being used by a central coordinator for aggregation of results and reporting purposes.

FIG. 38 is a process flow diagram depicting classification variable processing being performed at the node coordinators in order to provide query results to a user computer.

FIGS. 39 and 40 are block diagrams depicting a multi-user environment involving a grid computing environment.

FIGS. 41 and 42 depict an example for market stress testing purposes.

### DETAILED DESCRIPTION

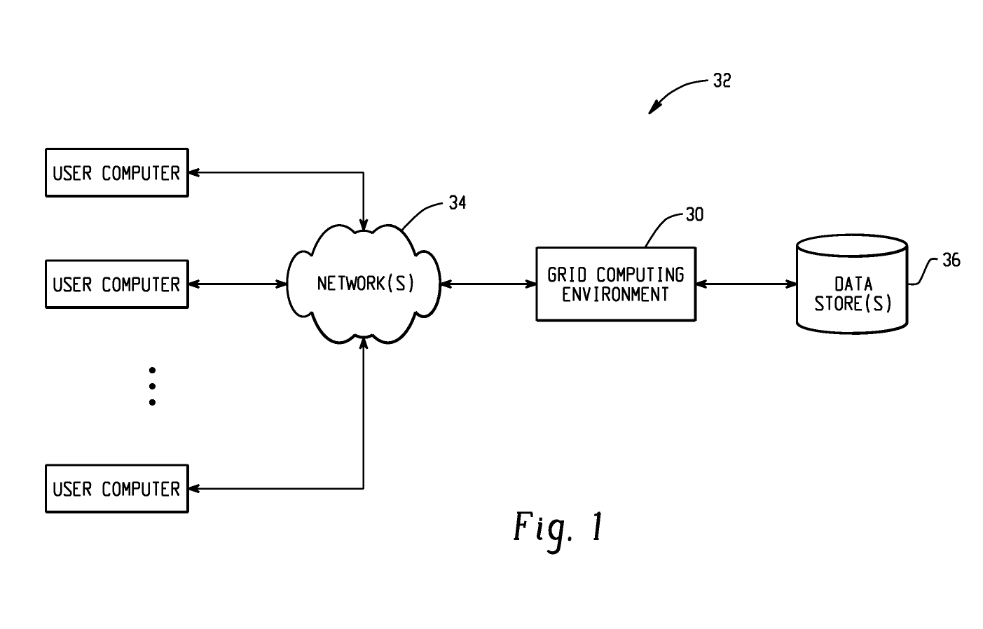

FIG. 1 depicts at 30 a grid computing environment for processing large amounts of data for many different types of applications, such as for scientific, technical or business applications that require a great number of computer processing cycles. User computers 32 can interact with the grid computing environment 30 through a number of ways, such as over one or more networks 34.

One or more data stores 36 can store the data to be analyzed by the grid computing environment 30 as well as any intermediate or final data generated by the grid computing environment. However in certain embodiments, the configuration of the grid computing environment 30 allows its operations to be performed such that intermediate and final data results can be stored solely in volatile memory (e.g., RAM), without a requirement that intermediate or final data results be stored to non-volatile types of memory (e.g., disk).

This can be useful in certain situations, such as when the grid computing environment 30 receives ad hoc queries from a user and when responses, which are generated by processing large amounts of data, need to be generated on-the-fly. In this non-limiting situation, the grid computing environment 30 is configured to retain the processed information within the grid memory so that responses can be generated for the user at different levels of detail as well as allow a user to interactively query against this information.

In addition to the grid computing environment 30 handling such large problems, the grid computing environment 30 can be configured to allow a user to pose multiple ad hoc questions and at different levels of granularity. For example, a user may inquire as to what is the relative risk exposure a particular set of stocks might have in the oil sector. To respond to this type of inquiry from the user, the grid computing environment 30 aggregates all of the oil sector price information together and makes a determination of the exposure that might exist in the future for the oil sector. Upon viewing the results, the user may wish to learn which specific oil company stocks are contributing the most amount of risk. Without an OLAP or relational database environment being required, the grid computing environment 30 aggregates all of the oil company price information and makes a determination of the company-level risk exposure that might exist in the oil sector in the future. Additionally, because the underlying data results are retained throughout the queries of the user, the grid computing environment 30 can provide other items of interest. For example, in addition to a user's earlier query involving Chevron and Exxon stock, the user now wishes to add Sun oil to the portfolio to see how it is affected. In response, the grid computing environment 30 adds position pricing information that has already been generated and retained in memory for Sun oil as well as for the other companies. As another example, the user can specify in a subsequent query that they wish to reduce their number of Exxon stock and have that position analyzed.

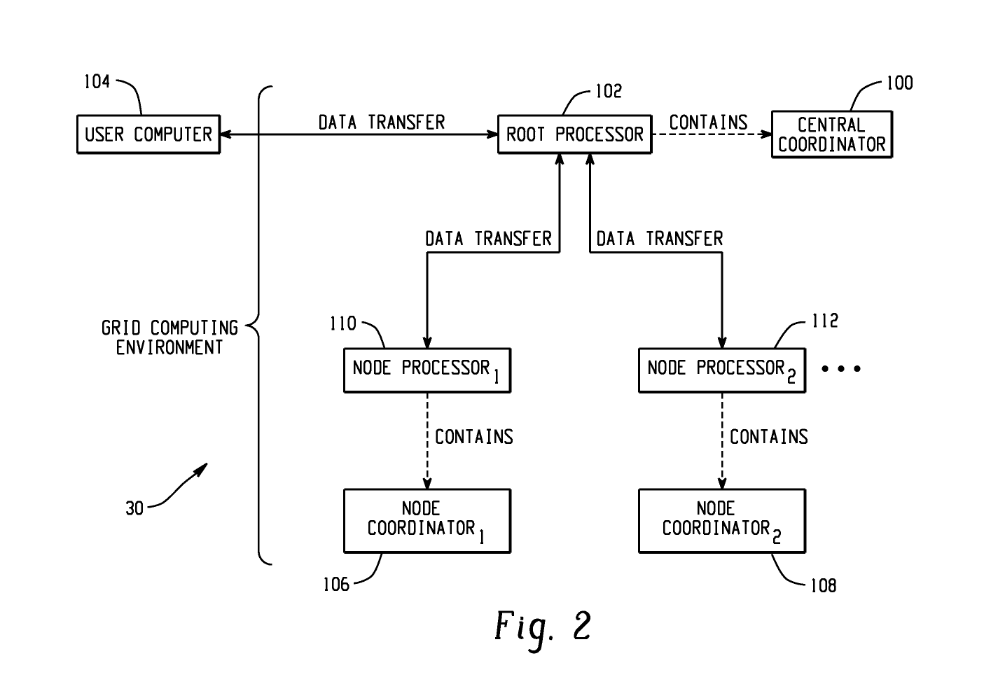

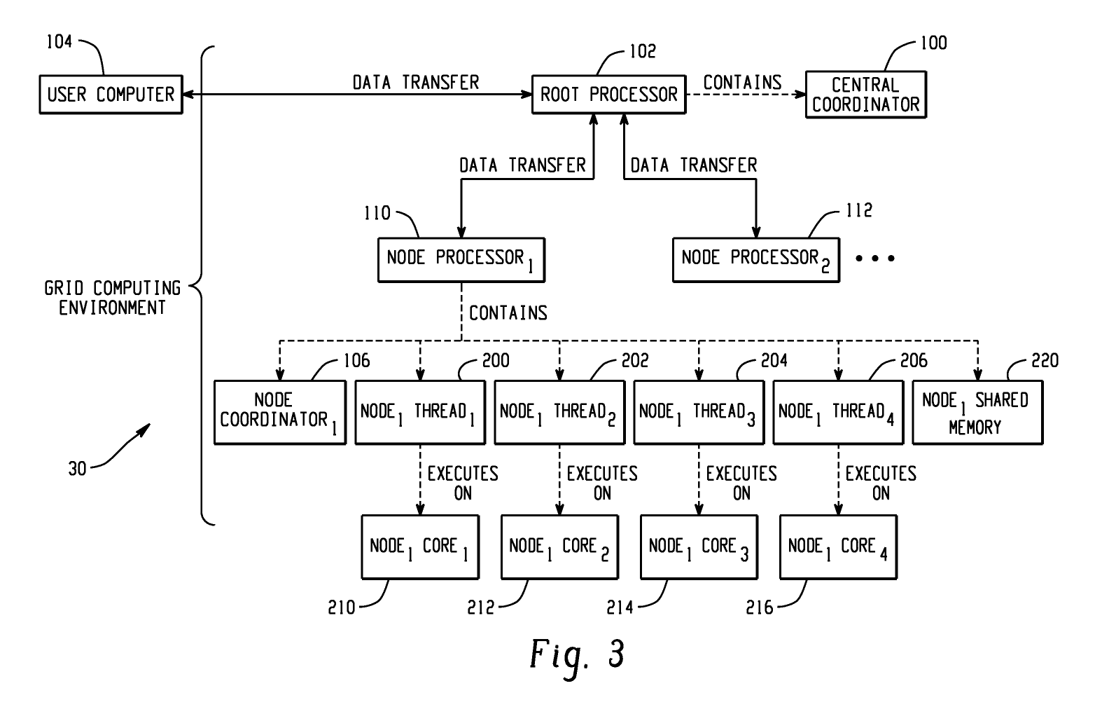

FIGS. 2 and 3 illustrate hardware and software components for the grid computing environment 30. With reference to FIG. 2, the grid computing environment 30 includes a central coordinator software component 100 which operates on a root data processor 102. The central coordinator 100 of the grid computing environment 30 communicates with a user computer 104 and with node coordinator software components (106, 108) which execute on their own separate data processors (110, 112) contained within the grid computing environment 30.

As an example of an implementation environment, the grid computing environment 30 can comprise a number of blade servers, and a central coordinator 100 and the node coordinators (106, 108) are associated with their own blade server. In other words, a central coordinator 100 and the node coordinators (106, 108) execute on their own respective blade server. In this example, each blade server contains multiple cores, and as shown in FIG. 3, a thread (e.g., threads 200, 202, 204, 206) is associated with and executes on a core (e.g., cores 210, 212, 214, 216) belonging to a node processor (e.g., node processor 110). A network connects each blade server together.

The central coordinator 100 comprises a node on the grid. For example, there might be 100 nodes, with only 50 nodes specified to be run as node coordinators. The grid computing environment 30 will run the central coordinator 100 as a 51st node, and selects the central coordinator node randomly from within the grid. Accordingly, the central coordinator 100 has the same hardware configuration as a node coordinator.

As shown in FIG. 3, the central coordinator 100 receives information and provides information to a user regarding queries that the user has submitted to the grid. The central coordinator 100 is also responsible for communicating with the 50 node coordinator nodes, such as by sending them instructions on what to do as well as receiving and processing information from the node coordinators. In one implementation, the central coordinator 100 is the central point of contact for the client with respect to the grid, and a user never directly communicates with any of the node coordinators.

With respect to data transfers involving the central coordinator 100, the central coordinator 100 communicates with the client (or another source) to obtain the input data to be processed. The central coordinator 100 divides up the input data and sends the correct portion of the input data for routing to the node coordinators. The central coordinator 100 also may generate random numbers for use by the node coordinators in simulation operations as well as aggregate any processing results from the node coordinators. The central coordinator 100 manages the node coordinators, and each node coordinator manages the threads which execute on their respective machines.

A node coordinator allocates memory for the threads with which it is associated. Associated threads are those that are in the same physical blade server as the node coordinator. However, it should be understood that other configurations could be used, such as multiple node coordinators being in the same blade server to manage different threads which operate on the server. Similar to a node coordinator managing and controlling operations within a blade server, the central coordinator 100 manages and controls operations within a chassis.

As shown in FIG. 3, a node processor includes shared memory (e.g., shared memory 220) for use for a node coordinator and its threads. The grid computing environment 30 is structured to conduct its operations (e.g., matrix operations, etc.) such that as many data transfers as possible occur within a blade server (i.e., between threads via shared memory on their node) versus performing data transfers between threads which operate on different blades. Such data transfers via shared memory is more efficient than a data transfer involving a connection with another blade server.

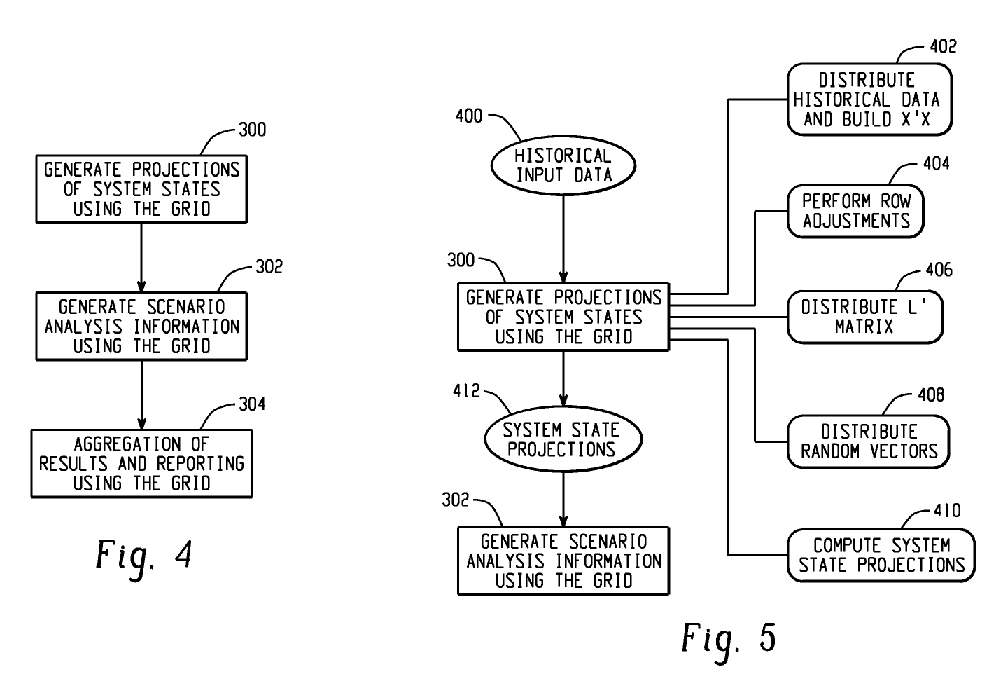

FIG. 4 depicts a process flow of a grid computing environment which has been configured for performing such scenario state processing as risk pricing of stock portfolios. The central coordinator and node coordinators of the grid computing environment are configured to efficiently perform matrix decomposition processes (e.g., factorization of a matrix) upon input data to project system states. Stochastic simulations are performed at 300 using the matrix factorization to generate system state projections. The system state projections are used to generate at 302 scenario analysis information at the node coordinators. The scenario analysis information generated at the node coordinators is then aggregated at 304 by the central coordinator and used to respond to user queries.

FIG. 5 illustrates a set of operations for using the central coordinator and node coordinators to generate system state projections. In the example of FIG. 5, the central coordinator and node coordinators of the grid computing environment are configured to process the input data 400 to form a cross product matrix (X′X matrix). To form the X′X matrix, the central coordinator at 402 breaks up and distributes historical data to the node coordinators so that a matrix decomposition (X′X) of the input data 400 can be performed at the node coordinators.

The X′X matrix is further processed by performing at the node coordinators adjustments at 404 to the X′X rows of data stored at the node coordinators. This processing results in obtaining a root, such as a Cholesky root (L′ matrix). To generate the system state projections 412, stochastic simulations are performed at 410 at the node coordinators based upon the generated L′ matrix that was distributed to the node coordinators at 406 and based upon vectors of random numbers that were distributed to the node coordinators at 408. After the system state projections are calculated, each node coordinator will have a roughly equal number of system state projections, with each system state containing values for all of the factors from the input data.

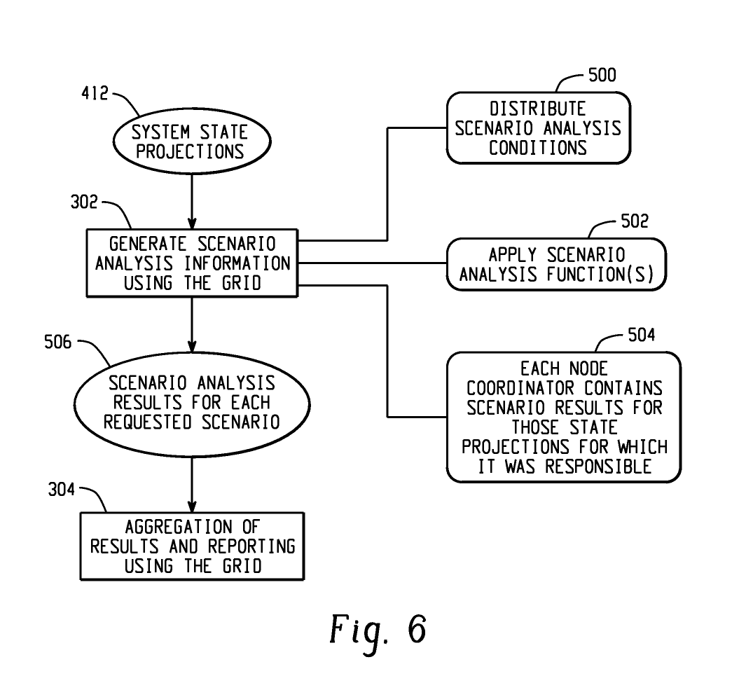

FIG. 6 depicts functionality directed to using the system state projections 412 for generating scenario analysis results 506. As input data to the scenario analysis generation function 302, a user provides the scenario conditions under which the scenario analysis is to be conducted. For example, scenario conditions for a financial scenario analysis can include position information for different stocks to be evaluated.

The scenario condition information provided by the user is received by the central coordinator and distributed at 500 by the central coordinator to the node coordinators. Each node coordinator instructs its threads to call scenario analysis functions at 502 for the system state projections that are present on that node. When this is accomplished, each node coordinator has scenario analysis results for the system state projections for which it is responsible as shown at 504.

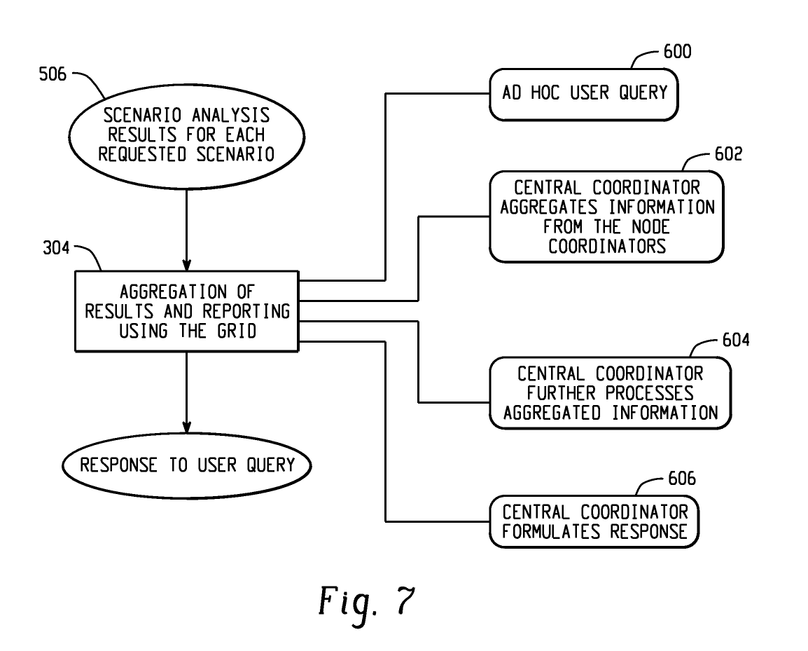

FIG. 7 depicts functionality directed to aggregating results from the node coordinators and using the results to respond at 606 to ad hoc user queries received at 600. The central coordinator receives the individual scenario analysis results 506 from each node coordinator. The central coordinator aggregates at 602 the individual scenario analysis results at a level which answers the query from the user. The central coordinator may also perform at 604 additional mathematical operations (e.g., descriptive statistical operations) on the aggregated data for review by the user.

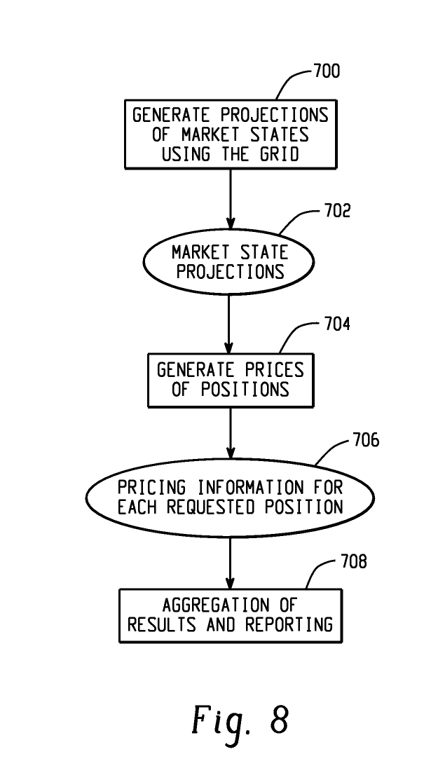

FIG. 8 depicts a market state generation and risk pricing application using a grid computing environment. This risk pricing application considers how history affects individuals with respect to future risk of loss on stocks, loans, bonds, etc. For example, if an individual owns Chevron and Exxon stock, then the grid computing environment examines historical information for the risk factors which are relevant to such stocks. Risk factors are a set of variables that describe the economic state of the system under consideration. Each risk factor has different attributes and behaviors and is a unique contributor to the economic environment. Within the example of analyzing Chevron and Exxon stock, risk factors might include the price of oil, currency exchange rates, unemployment rates, etc.

The grid computing environment examines the history of these risk factors to determine how it may affect stock prices. The grid computing environment then projects forward from the risk factor historical data (e.g., via a stochastic model) by generating at 700 market state projections 702 for all of the risk factors. For example, market state projections in this field may examine how oil prices varied over the past couple of years as well as currency, and then perform stochastic simulations using the historical risk factor data to project how they might possibly perform in the future (e.g. over the next year).

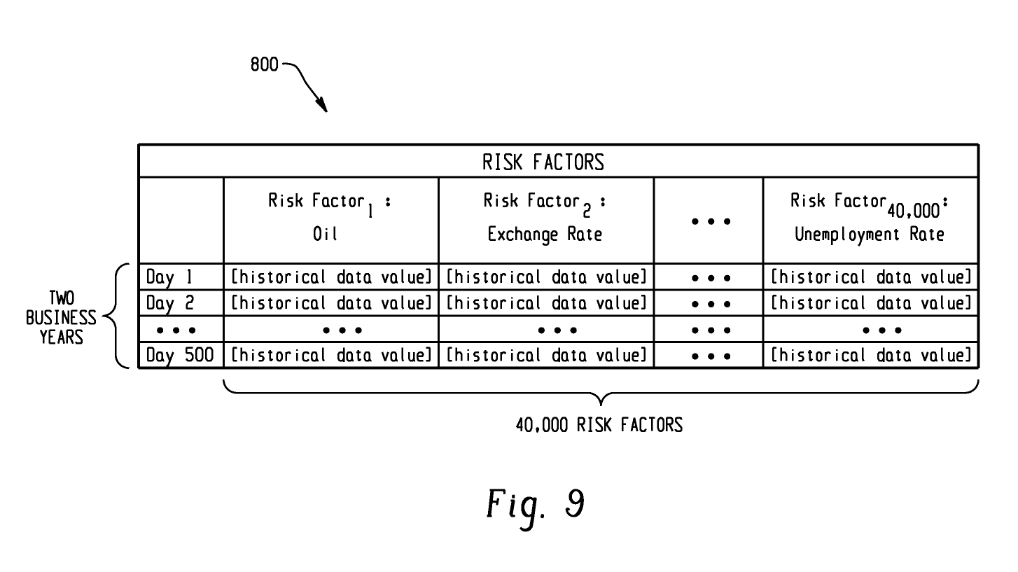

As an illustration, the grid computing environment is provided with several years of historical information for the risk factors. As shown at 800 in the example of FIG. 9, two business years of information has been collected for the risk factors for each business day, which amounts to 500 days of information. From this information, the grid computing environment generates market state projections for each risk factor. For example, a market state projection for oil prices may indicate that the price of oil will vary between $50-$90 over the next year. Another market state projection may examine how the dollar will vary over that period. The market state projections are used to examine the different ways in which the market might perform.

For each of these market states (e.g., oil is at $75 over the next year on average, and the dollar will be $1.39 to the euro, and unemployment will 10%), the grid computing environment examines how much a person's 200 shares of Exxon stock will be worth, and similarly, how much the person's 300 shares of Chevron stock will be worth. The grid computing environment takes each of the market state projections into the future, and generates a price for the different stock positions.

To achieve a relatively high level of confidence, a large number of risk factors is examined. As an illustration, the number of risk factors in FIG. 9 is 40,000. Additionally, the grid computing environment may wish to generate tens of thousands of market state projections because of the need for a relatively high level of confidence.

With reference to FIG. 9, in addition to risk factor historical data being input into the grid computing environment, the number of business days (“n”) and the number of external risk factors that affect stock price (“p”) are provided. As an illustration, the number of business days (“n”) for which historical data has been collected for the external risk factors is 500 business days (i.e., the data has been collected for two business years); and the number of external risk factors (“p”) is 40,000 variables (e.g., exchange rate, unemployment rate, consumer confidence, etc.). This forms an “n” by “p” matrix and is termed an “X” matrix. The size of the matrix illustrates the magnitude of the problem to be handled.

This input data set can be supplied by the user over a network and stored only in volatile memory, thereby helping, if needed, to mitigate security concerns. However, it should be understood that other situations may allow the input data set to be stored and provided on non-volatile medium.

For risk pricing applications which only involve a relatively small number of risk factors, processing time using conventional approaches can be acceptable. However, once the problem becomes inordinately large, such as having the grid computing environment track tens of thousands of risk factors (e.g., 40,000 risk factors), processing time can approach multiple days. In addition to the large number of risk factors, the issue is further exacerbated because to acquire a needed level of confidence, the grid computing environment must also generate thousands of market state projections (e.g., 10,000 or more market state projections). This only serves to increase further the overall amount of processing time required to handle such large data sets, with some runs using convention approaches lasting as many as 5-7 days.

As another indication of the relatively large nature of the problem, it is not uncommon for a user to provide a million positions to evaluate. With this number of positions to price and the grid computing environment generating 10,000 market state projections, this will result in 11 billion items to process. A grid computing environment as disclosed herein can be configured to efficiently handle such a large-scale problem.

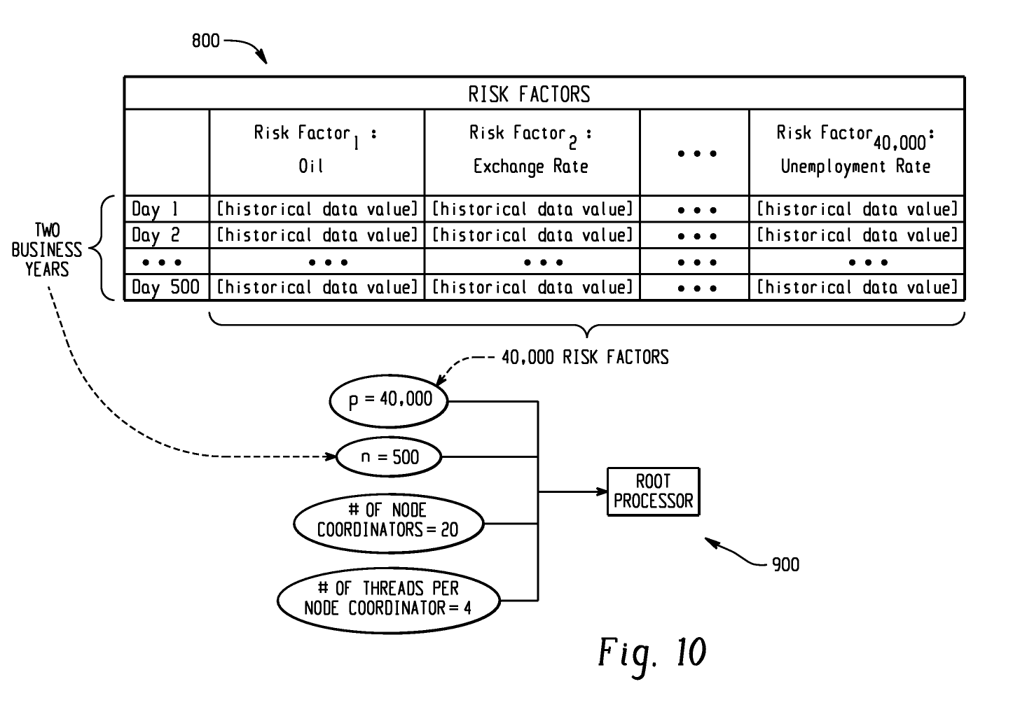

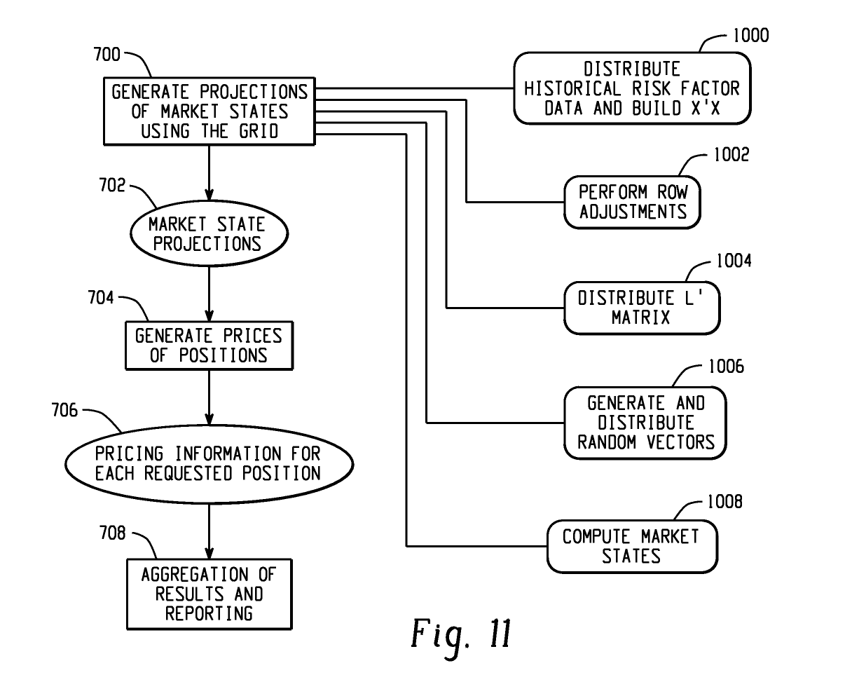

FIG. 10 depicts at 900 additional input data for generating market state projections. To determine how to allocate which portions of data a node coordinator is to handle, the central coordinator on the root processor receives not only the dimensions associated with the risk factor input data and the data itself, but also the configuration to be used within the grid computing environment. This type of information can include the number of node coordinators and the number of threads per node coordinator. For example, the number of node coordinators might be 20 and the number of threads per node coordinator might be 4.

With reference back to FIG. 8, the market state projections 702 form the basis for examining how the Chevron stock and Exxon stock will perform in the future and allow a user (e.g., a risk manager) to understand better what the exposure might be for a set of stocks, such as does an individual have a one in twenty chance of losing a certain amount of money from the performance of a given set of stocks over the next year? For each risk factor, the market state projections 702 into the future is an average of all of the different scenarios for the risk factor. A market state projection can be viewed as a curve which represents how a risk factor will vary over time.

To generate these curves for the risk factors, the grid computing environment uses stochastic simulation techniques. Stochastic simulation techniques differ from methods which use forecasting of risk factors to understand risk. For example, a forecasting model probably would not have predicted unemployment to have risen to 10% and beyond in 2009 because only a couple years ago it was much lower. In contrast, a stochastic simulation may have simulated a situation where unemployment did reach 10% and beyond in 2009.

After the market state projections are generated at 700, the next step involves pricing each of the positions at 704. A list of held stocks, bonds, or loans (e.g., positions) are received from the user. A pricing function uses this information as well as the generated market state projections to generate prices 706 for each of the positions under the different market state projections 702.

After the prices 706 of positions are generated, the next step is to process at 708 any queries from a user. Because the grid computing environment retains the pricing information on the grid, responses can be generated on the fly. In other words, the grid computing environment does not need to know beforehand what is to be asked. Previous approaches would have to pre-aggregate the data up to the level at which the user's question was asked (e.g., an industry sector level information), thereby losing more detailed pricing information (e.g., company-specific level information). In the grid computing environment disclosed herein, the grid computing environment keeps the lower level information live in memory and does not aggregate information until the grid computing environment receives a query from a user. Additionally, the pricing information staying out in the grid is in contrast to previous approaches wherein the data was written to a central disk location. The central disk location approach constituted a single point which operated as a bottleneck in the process.

FIGS. 11-38 depict an operational scenario for illustrating the processing of the input data shown in FIGS. 9 and 10. FIG. 11 depicts matrix operations and stochastic simulations that are used to generate market state projections. These operations include:

Distribute risk factor historical data and build an X′X matrix (at step 1000)

Perform row adjustments to create an L′ matrix (at step 1002)

Distribute the L′ matrix among the node coordinators (at step 1004)

Distribute random vectors among the node coordinators (at step 1006)

Compute market state projections (at step 1008)

Overall, these operations form a cross product matrix (X′X matrix) and then applies a forward Doolittle technique (or other equivalent approach) to obtain a Cholesky root (L′ matrix). Stochastic simulations are then performed using the Cholesky root to generate market state projections.

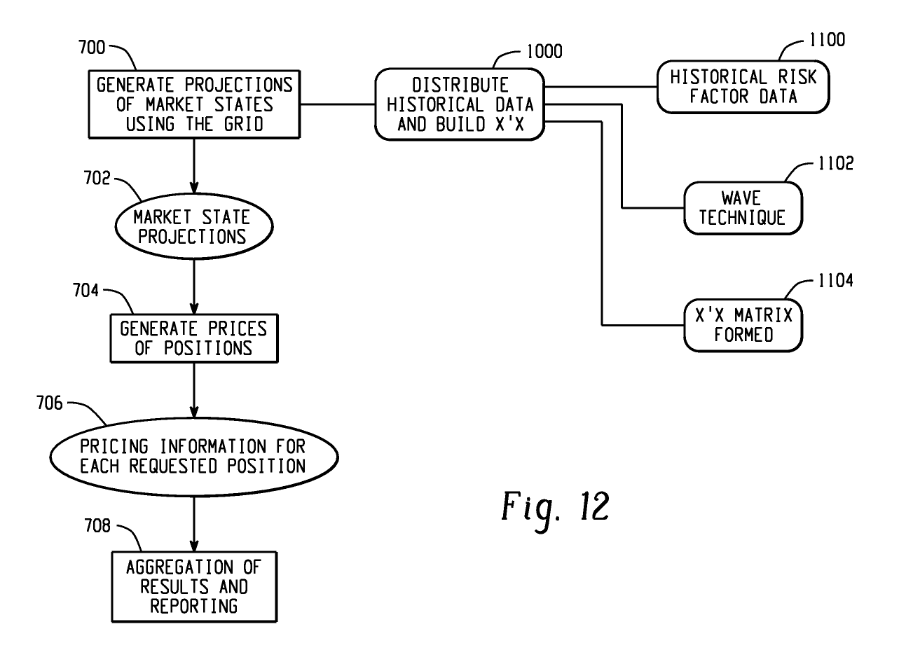

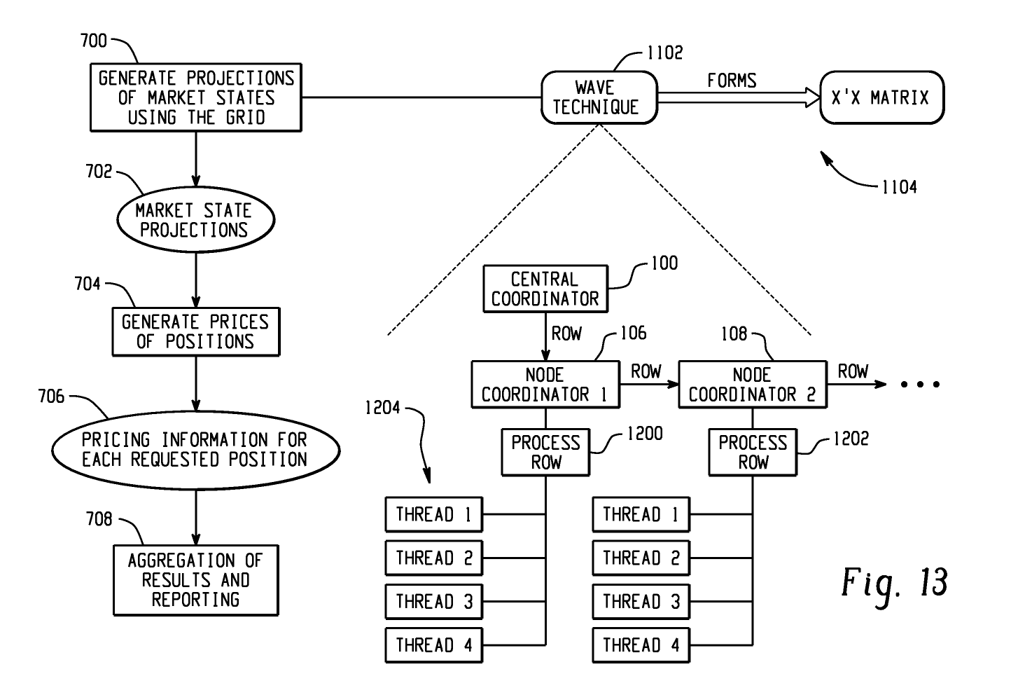

FIG. 12 is directed to a central coordinator distributing at 1000 risk factor historical data 1100 to the node coordinators for building at 1104 the X′X matrix. The central coordinator receives the input data from the client, and breaks up that information to pass it on to the node coordinators. The grid computing environment uses as shown at 1102 a wave technique for distributing and processing the data. FIG. 13 provides an illustration of the wave data distribution technique 1102, wherein the central coordinator 100 sends the first row to the first node coordinator 106. The first node coordinator 106 sends that row to the second node coordinator 108, and then the first node coordinator 106 processes the row at 1200. The second node coordinator 108 receives the row from the first node coordinator 106, sends it to the third node coordinator, and then processes at 1202 the row and so forth. The processing of a row by a node coordinator involves instructing its threads 1204 to read that row, and each thread will build a portion of the upper triangular matrix for which it is responsible. As soon as the first node coordinator 106 has completed processing the first row, it can receive the second row from the central coordinator 100. The second row is passed on to the subsequent node coordinators in a wave-like fashion similar to the way in which the first row was transmitted. There can be many waves of rows traveling down through the node coordinators at the same time. When all of the rows have been received and processed by the node coordinators, the X′X matrix will have been formed as shown at 1104 and stored in an upper triangular form across the node coordinators.

As an example using the data of FIG. 9, the grid computing environment starts with an X matrix which is “n” by “p” as shown in FIG. 9. From this data set, a “p” by “p” matrix (e.g., 40,000 by 40,000 matrix) is generated by the grid computing environment and is termed an X′X matrix. Once that matrix is determined, then a Cholesky root is taken. This is done by distributing the 40,000×40,000 matrix among the threads of the node coordinators. Each row is sent to the central coordinator, and then the central coordinator farms it out to the node coordinators using the wave data distribution and processing technique described above. Each node coordinator is provided with every row, but each node coordinator creates only a fraction of the overall matrix.

Accordingly, the grid starts with rows of the X matrix, and the calculated X′X matrix will be “p” by “p.” Because the matrix is symmetrical, only the upper or lower triangular portion of the matrix is stored. In this example, the upper triangular portion is stored.

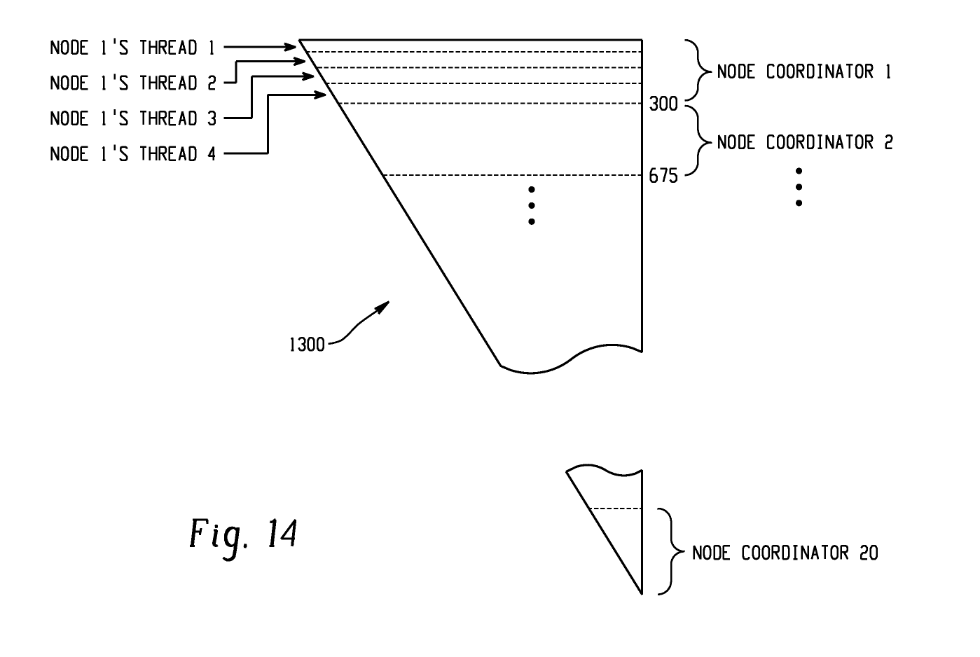

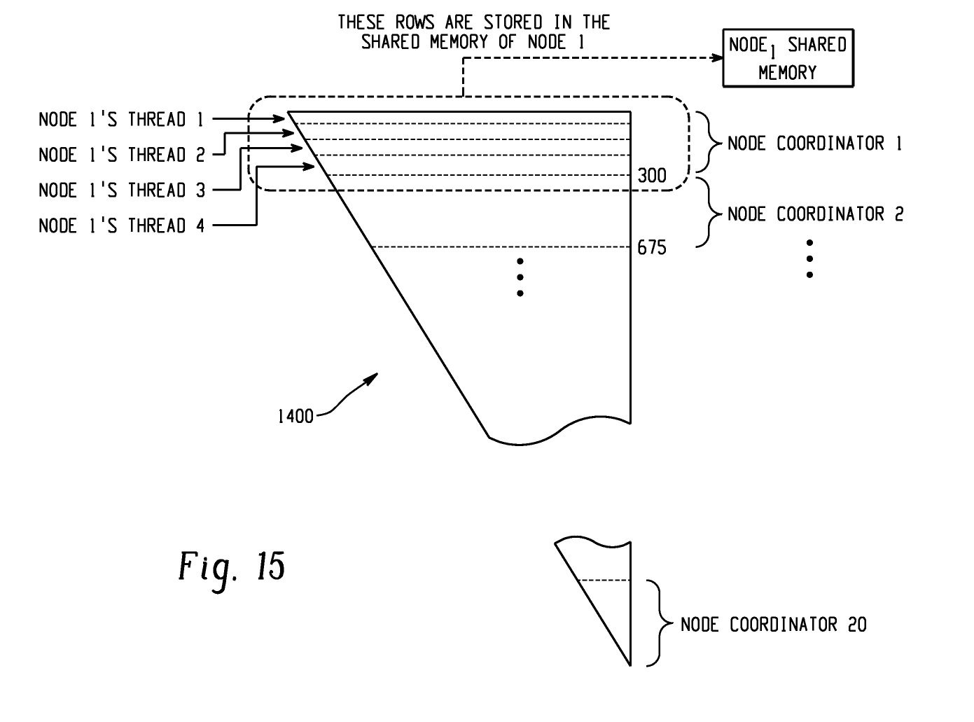

The processing of a row by a node coordinator involves instructing its threads to read that row, and each thread will build a portion of the upper triangular matrix for which it is responsible. The X′X matrix is stored in chunks as shown at 1300 in FIG. 14. The first chunk will be maintained by node coordinator 1, the second chunk will be maintained by node coordinator 2, etc. Within each node coordinator, each chunk is further divided among the threads of the node coordinator. As an illustration, FIG. 15 shows at 1400 that the rows associated with node 1's threads (i.e., threads 1-4) are stored in the shared memory of node 1.

Each node coordinator knows which portion of the triangle is its responsibility to construct based upon how many other nodes there are and how many threads per node there are (i.e., “n” and “p” of FIG. 10). The central coordinator indicates to a node coordinator which number it is, and this is sufficient for the node coordinator to know which portion of the matrix it is to handle as well as how to partition its portion into chunks for the number of threads that is associated with the node coordinator. The size of the portion which a node coordinator is to process is approximately the same as for any other node coordinator.

For example, the central coordinator can indicate to the 20 node coordinators that there will be 80 overall threads that will be working on a 40,000×40,000 size matrix. Based on this information, each node coordinator (e.g., node coordinators 1-20) knows on which portion of the matrix it is to work. The central coordinator then sends out a row from the n by p input matrix to a node coordinators. As an illustration in FIG. 15, node coordinator 2 recognizes that since it is the second node coordinator, that it is to process rows 300 to 675.

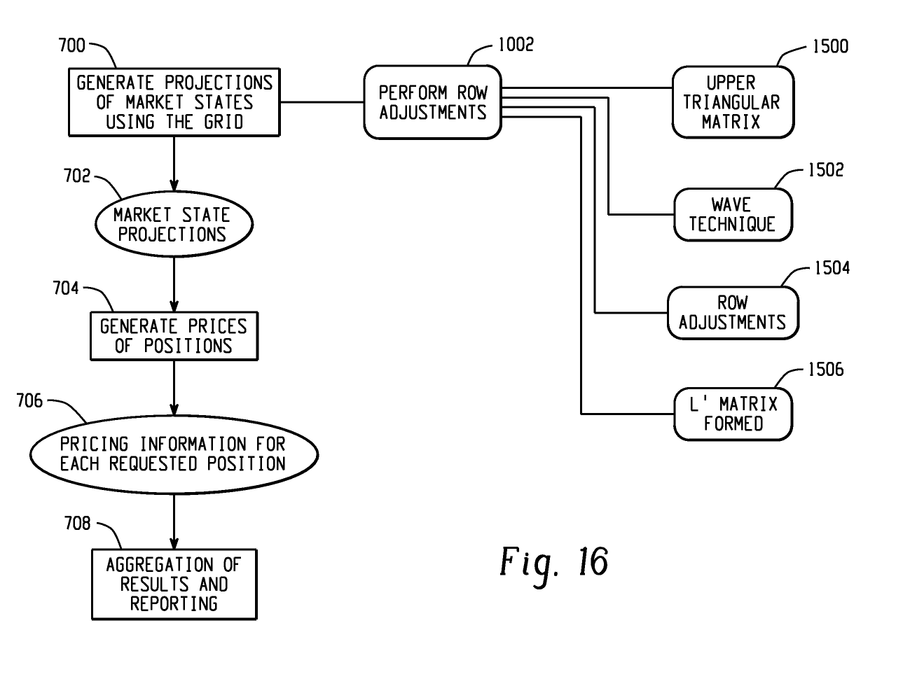

FIG. 16 depicts functionality directed to performing at 1002 row adjustments in order to construct the L′ matrix 1506. When performing the row adjustments 1504, each row of the upper triangular matrix 1500 is sent to each node coordinator, using the wave technique 1502 that helped distribute the input data and build the X′X matrix described above. The completion of this process results in the formation of the L′ matrix 1506.

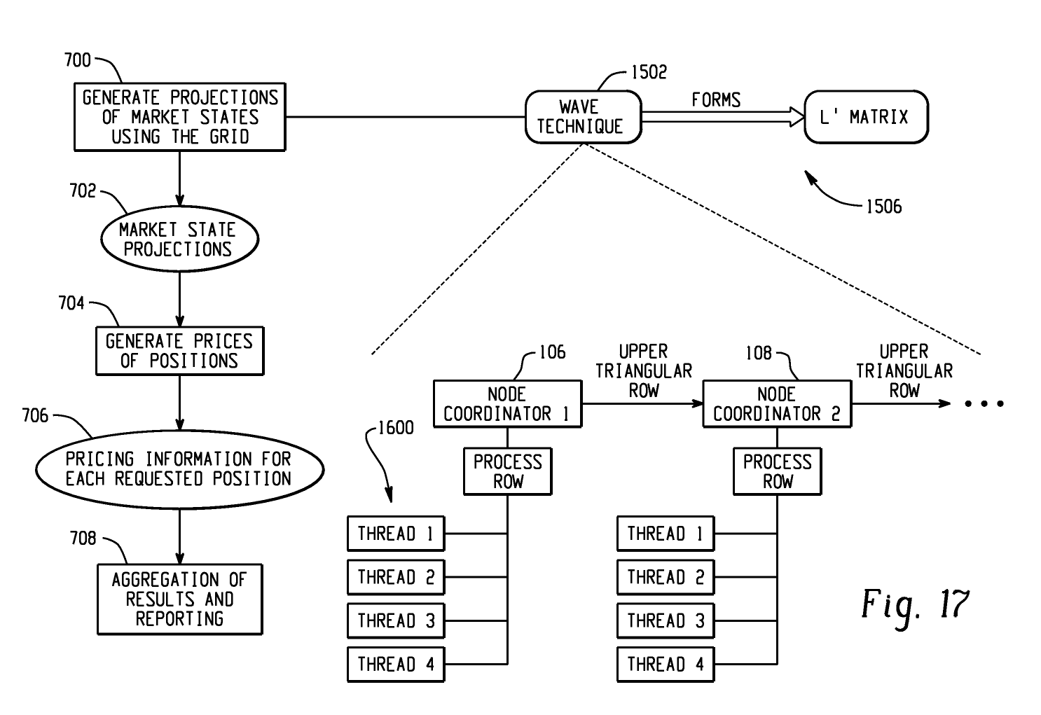

The wave technique of FIG. 16 is further illustrated in FIG. 17. With reference to FIG. 17, upon receipt of a row, each node coordinator instructs its threads to perform row adjustments to all rows that are greater than the transmitted row. More specifically, the first node coordinator 106 takes a row and sends it to the second node coordinator 108, and then the first node coordinator 106 instructs its threads 1600 to process that row. The second node coordinator 108 sends the row to the third node coordinator, and then the second node coordinator 108 processes it.

When a node coordinator finishes processing, it can begin the next iteration of processing. This can occur even if subsequent node coordinators have not completed their first iteration of processing. For example, if node coordinator 3 completes its processing for the first iteration, then node coordinator 3 can begin processing for the second iteration (i.e. the data provided during the second wave) even if a subsequent node coordinator has not completed its processing for the first iteration.

To form the L′ matrix using the wave technique, the node coordinators perform a Cholesky decomposition upon the X′X matrix. For this, the grid computing environment uses a forward Doolittle approach. The forward Doolittle approach for forming the Cholesky decomposition results in a decomposition of a symmetric matrix into the product of a lower or upper triangular matrix and its transpose. The forward Doolittle approach is discussed further in: J. H. Goodnight, A Tutorial On The Sweep Operator, The American Statistician, vol. 33, no. 3 (August 1979), pp. 149-158. (This document is incorporated herein by reference for all purposes.)

The forward Doolittle approach essentially performs Gaussian elimination without the need to make a copy of the matrix. In other words, the grid computing environment constructs the L′ matrix as the grid computing environment goes through the matrix (i.e., as the grid computing environment sweeps the matrix a row at a time). As the node coordinators work on it, they create an inverse matrix. Because of this, storage of the entire matrix is not needed and can be done in place, thereby significantly reducing memory requirements.

For example, the Doolittle approach allows the grid computing environment to start at a row and adjust all rows of the node coordinators below it and the grid computing environment is not required to go back up. For example, if the grid computing environment were on row three, then the grid computing environment never needs to go back up to rows one and two of the matrix. Whereas if it were a full sweep, the grid would have to go back to earlier rows in order to make the proper adjustments for the current row. This allows the grid to send out a row that is being operated upon by other nodes, and when a node coordinator receives that row to work on, the node coordinator already has everything that it needs to make the adjustment to that portion of the row. Accordingly, the grid computing environment can do this very efficiently by only having to go through the matrix twice to form the L′ matrix. Additionally, each node coordinator is given approximately the same amount of work to do. This prevents bottlenecks from arising if a node coordinator takes longer to complete its task.

Upon completion of the row adjustments by the threads of all of the node coordinators, the X′X matrix will have been adjusted for all rows and is now an L′ matrix distributed among the node coordinators.

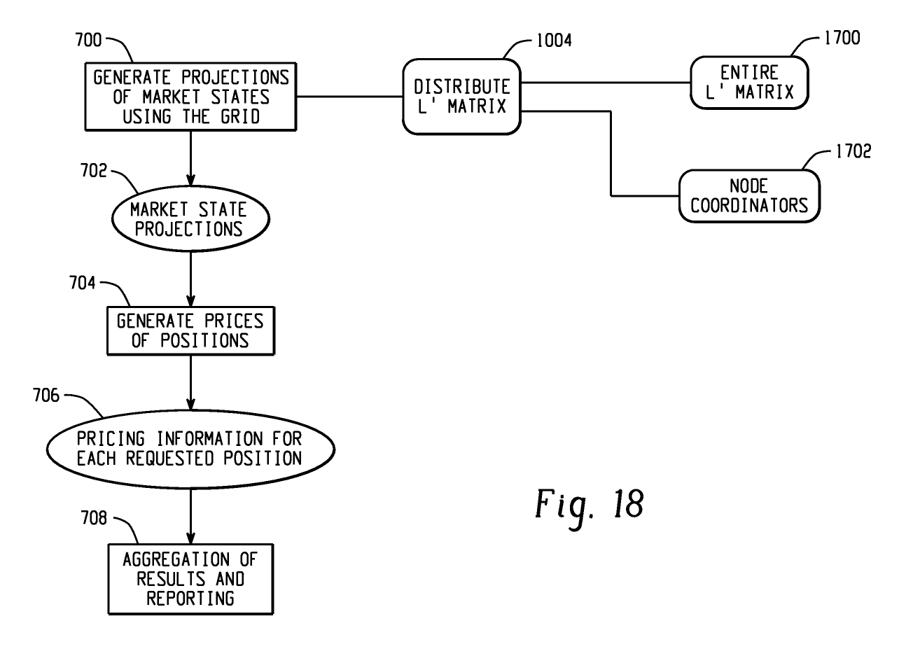

To complete the market state projection calculations, the node coordinators are provided with the entire L′ matrix as illustrated at 1700 in FIG. 18. To accomplish this, each node coordinator 1702 sends its portion of the L′ matrix to all other node coordinators. Another approach is to have a node coordinator report its portion directly to the central coordinator so that the central coordinator can assemble all of the node coordinators' results and then distribute the entire matrix to all of the node coordinators. At the end of this processing, each node coordinator has a full copy of the L′ matrix.

While other approaches can be used (e.g., another approach is to generate the market state projections using the distributed L′), the approach to provide the entire L′ matrix to the node coordinators is used because the generated L′ matrix contains a significant number of zeros. Because of this, a subset of L′ is formed, which is, in this example, a 500×40,000 matrix that is distributed to the node coordinators. Additionally, an advantage of each node coordinator having the L′ matrix is that the subsequent market state projections can be calculated more quickly because this obviates the requirement for a node coordinator to have to fetch additional rows of information when calculating market states. Because each node coordinator is no longer storing just its portion of the L′ matrix, a reconfiguration of the node's memory is done to transition from the storage of only a node coordinator's specific portion of the L′ matrix to storing the entire L′ matrix for the 500×40,00 matrix.

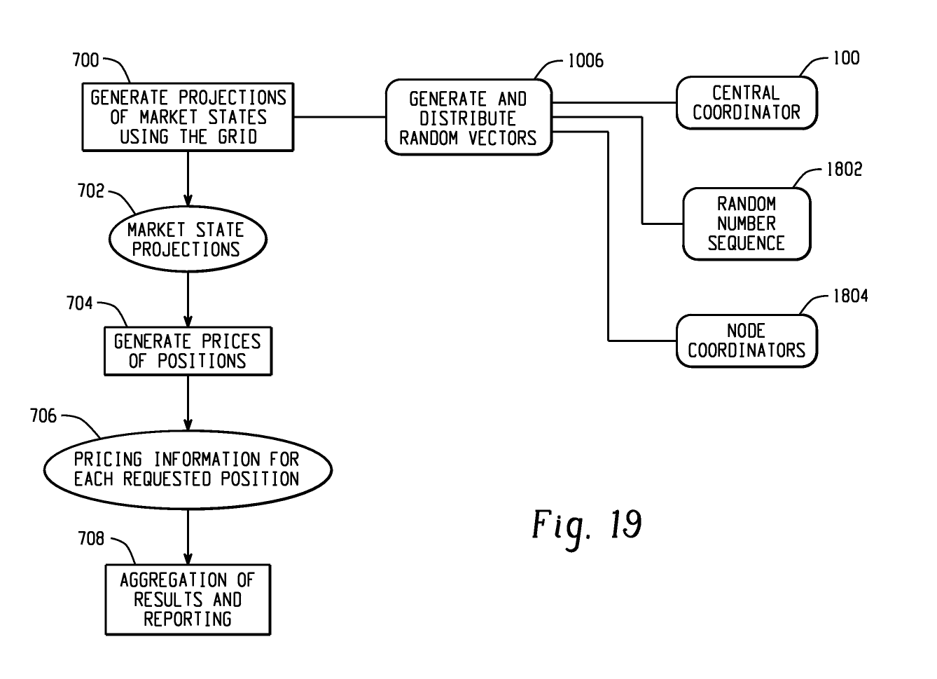

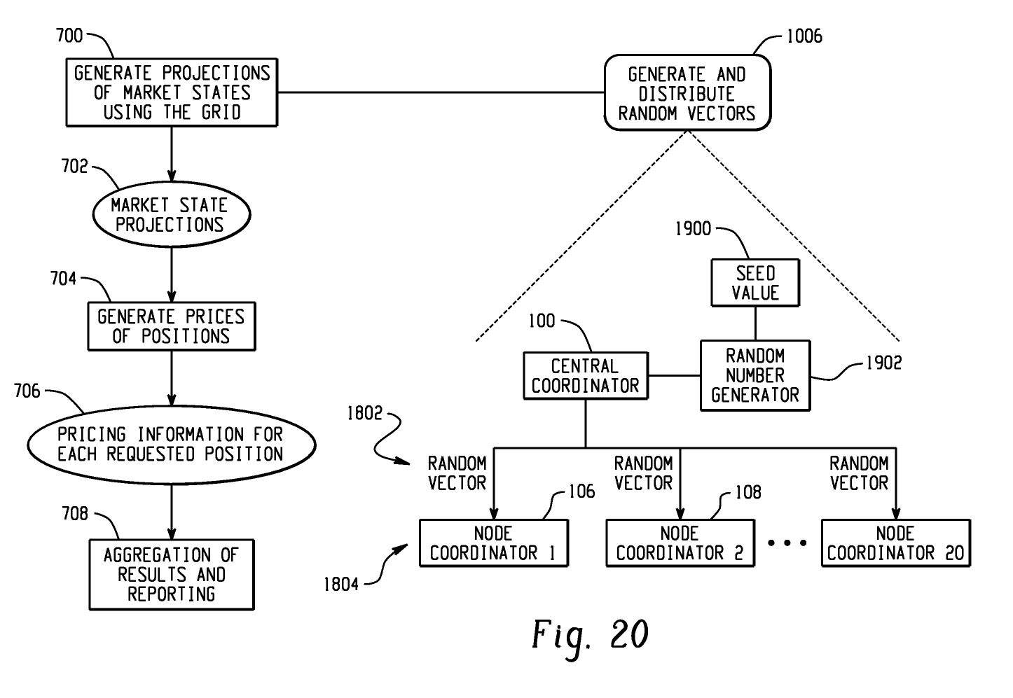

FIG. 19 depicts functionality at 1006 directed to generating and distributing random vectors 1802 to the node coordinators 1804. As shown in FIG. 20, the random vectors 1802 are for use by the node coordinators to perform market state simulations. If desired, the central coordinator 100 generates all of the random numbers 1802 by using a seed value 1900 and a random number generator 1902 and sends each node coordinator 1804 a portion (e.g., a vector) of the generated random numbers 1802.

As an alternative, the grid computing environment could have each node coordinator individually generate the random numbers it needs for its simulation operations. However, this alternate approach may exhibit certain drawbacks. For example, random numbers are typically generated using seeds. If each node coordinator starts with a predictable seed, then a deterministic set of random numbers (e.g., a reproducible sequence) may arise among the node coordinators. For example if the root seed is 1 for a first node coordinator, the root seed is 2 for a second node coordinator, and so forth, then the resulting random numbers of the node coordinators may become deterministic because of the progressive and incremental values of the seeds for the node coordinators.

Because the central coordinator generates and distributes the random numbers for use by the node coordinators, it is ensured that the random numbers utilized by the node coordinators do not change the ultimate results whether the results are generated with two node coordinators or twenty node coordinators. In this approach, the central coordinator uses a single seed to generate all of the random numbers that will be used by the node coordinators and will partition the random numbers among the node coordinators.

The grid computing environment can be configured such that while the node coordinators are constructing the L′ matrix, the central coordinator is constructing a vector of random numbers for subsequent use by the node coordinators in generating markets state projections.

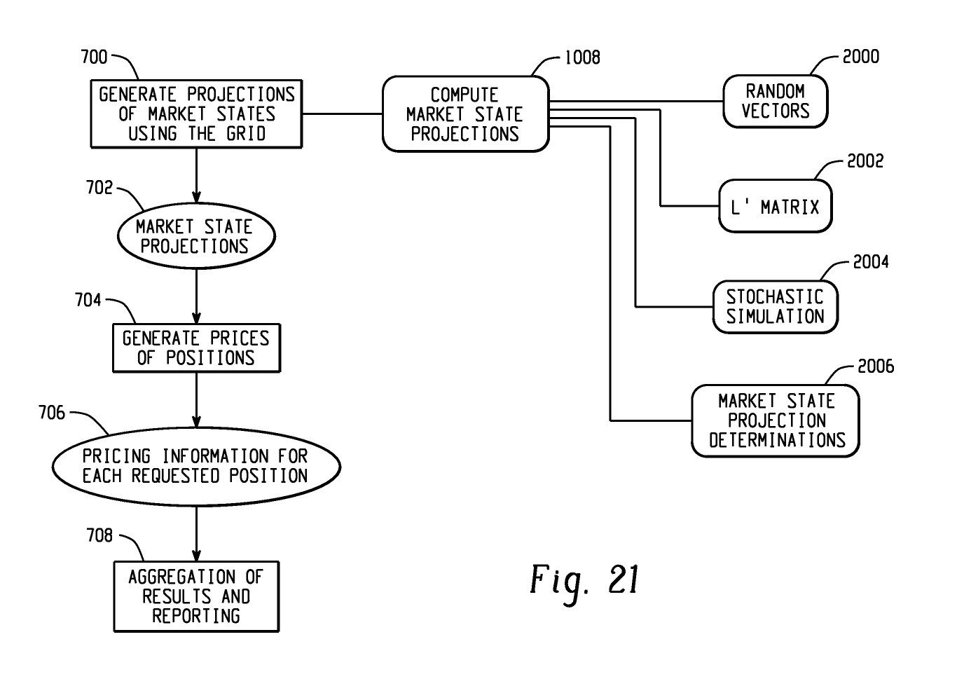

FIG. 21 depicts functionality at 1008 directed to computing market state projections based upon the L′ matrix 2002 and stochastic simulation 2004. More specifically, the random vectors 2000 are multiplied by the L′ matrix 2002 to produce the market state projections at 2006. The work is performed by the threads under each node coordinator. After the market state projections are calculated, each node coordinator will have a roughly equal number of system state projections, with each system state containing values for all of the factors from the input data.

More specifically, the market state projections are determined by computing a UL′ matrix, wherein U is a vector of random numbers. The calculations are repeated K times for K different random vectors, wherein K is selected by the user (e.g., K equals 10,000). A value of 10,000 for K results in 10,000 vectors of size 40,000 each for use in generating market state projections. Additionally, the market state projections are calculated by adding a base case to UL'. (The large number of market state projections can be needed to reach a relatively high degree of confidence.)

With respect to the base case, the market state projections generated by a node coordinator are generated from the base case, which in this example, comprise current values of the risk factors. For example, in the case of the oil price risk factor, the base case can be the current values for oil prices.

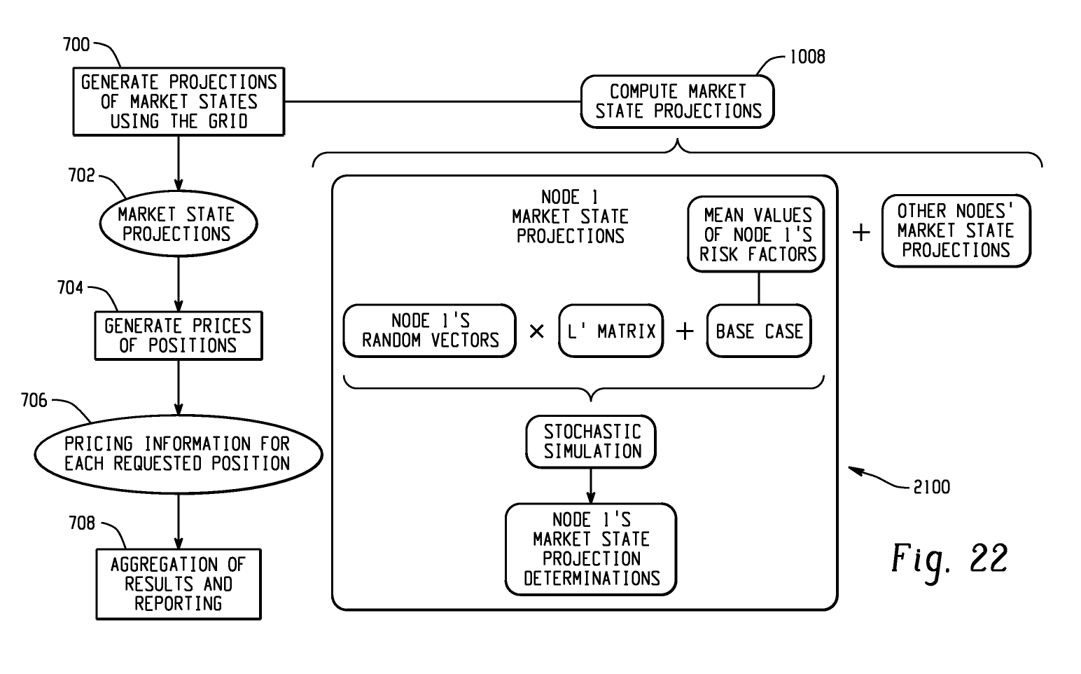

FIG. 22 depicts at 2100 that with respect to the node coordinators, each node coordinator generates a subset of the overall request of the market state projections. For example, if 10,000 market state projections are to be generated and there are 100 node coordinators, then each node coordinator will generate 100 market state projections for each of the risk factors. Each node coordinator knows what market state projections it needs to calculate because each node coordinator knows where in the chain of node coordinators it is. More specifically, the node coordinator uses the number of samples in the number of node coordinators to identify which market state projections it needs to calculate. This also determines how many random numbers in a vector need to be sent to a node coordinator to compute its portion of the market state projections. As an illustration, the grid computing environment takes the overall number of samples and divides by the number of node coordinators and then see how many are extra which are divided as equally as possible among as many node coordinators are needed to handle the extra data items. This can help assure that each node coordinator is doing approximately the same amount of market state projections as any other. In this situation, the node coordinators differ only by at most one additional market state projection.

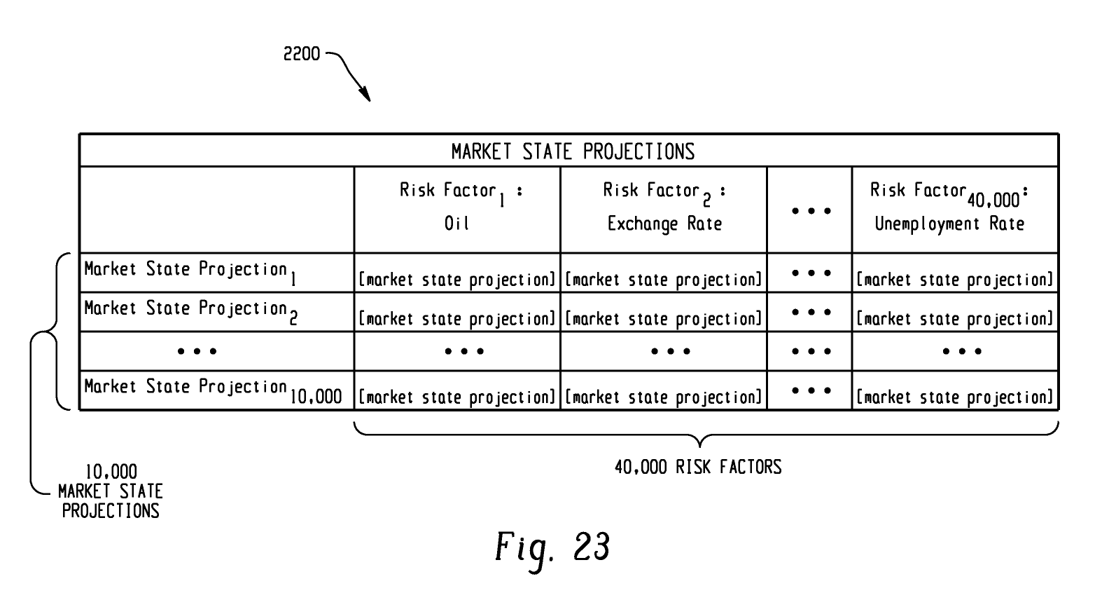

FIG. 23 depicts at 2200 an example of market state projection results. The results illustrate that the grid computing environment has computed 10,000 market state projections for each of the 40,000 risk factors.

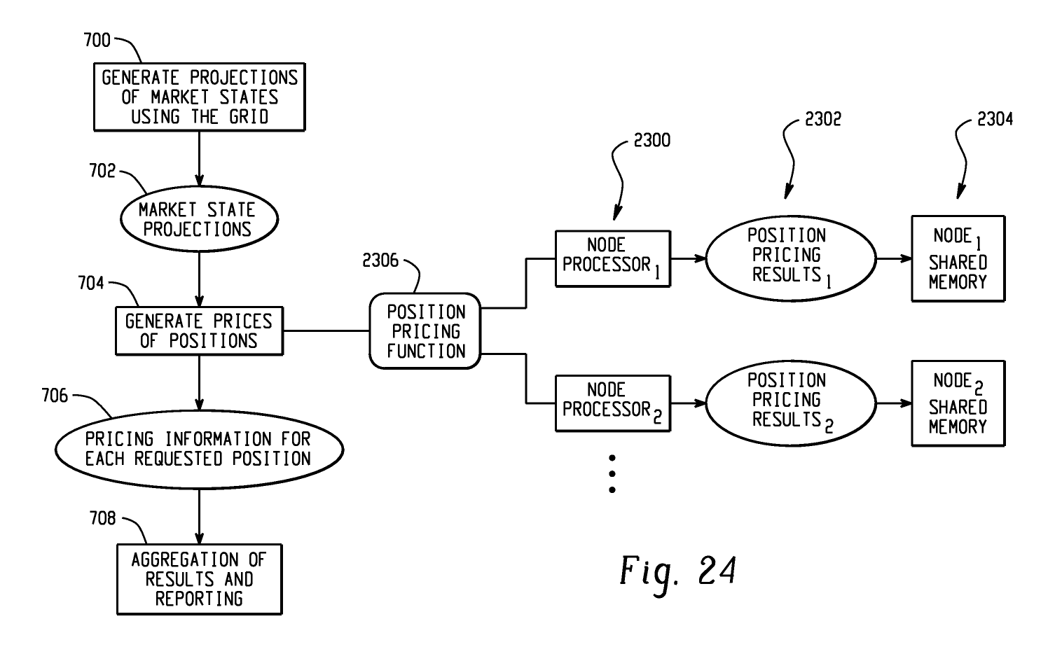

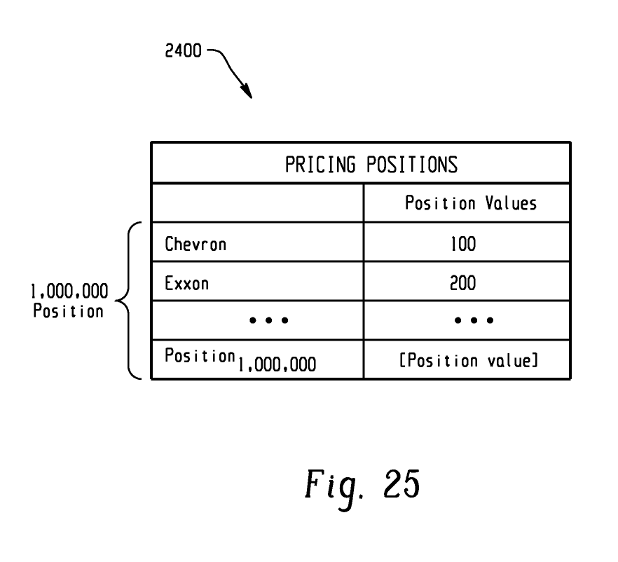

FIG. 24 depicts node processors 2300 using the market state projections to generate though function 2306 position pricing results 2302 which are stored in their respective shared memories. As input data to the scenario analysis generation function, a user provides positions information under which the analysis is to be conducted. For example, positions information for a financial scenario analysis can include position values for different stocks, bonds, or loans to be evaluated. As illustrated at 2400 in FIG. 25, the number of positions to be analyzed can be quite large (e.g., 1,000,000). Other situations may reach 1,000,000,000 positions to be analyzed.

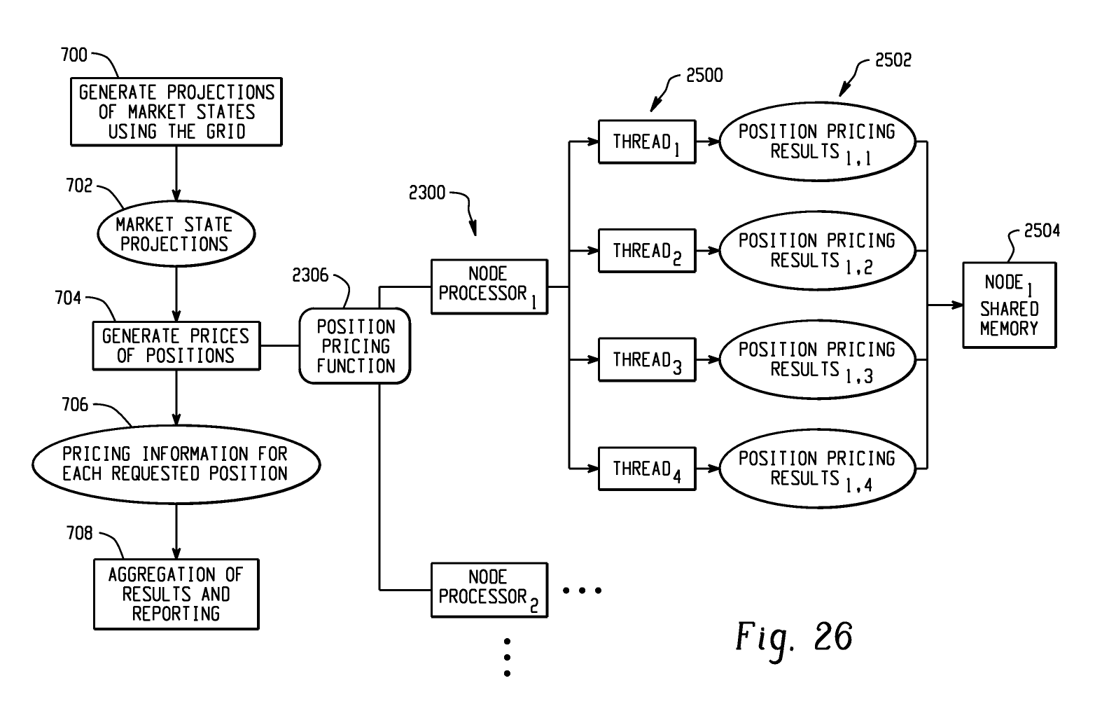

To help expedite processing of the positions, each thread of a node is assigned a particular portion of the problem to solve. As an illustration, FIG. 26 depicts at 2500 threads 1-4 generating different position pricing results 2502 for storage in the shared memory 2504 of node 1. An operational scenario can include thread 1 of node 1 being assigned to use a certain subset of market state projections to calculate prices for all positions, thread 2 of node 1 being assigned to use a different subset of market state projections to calculate prices for all positions, etc.

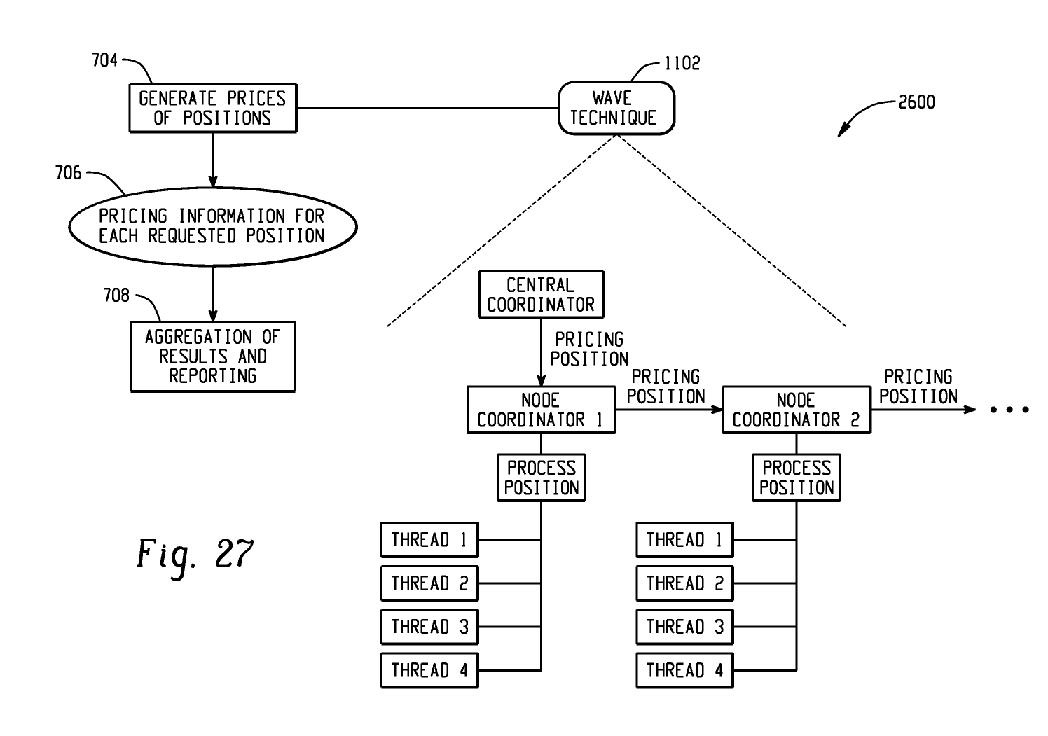

FIG. 27 illustrates at 2600 a mechanism for distributing the positions provided by a user to the nodes. Similar to the wave technique described above, the central coordinator sends position information to node coordinator 1, which then sends the position information to node coordinator 2, then node coordinator 2 sends the position information to node coordinator 3, etc. Each node coordinator instructs its threads to call pricing functions for the market state projections that are associated with a node coordinator. After a node coordinator receives a position and then sends it on to the next node coordinator, the node coordinator generates pricing based upon which market state projections it has.

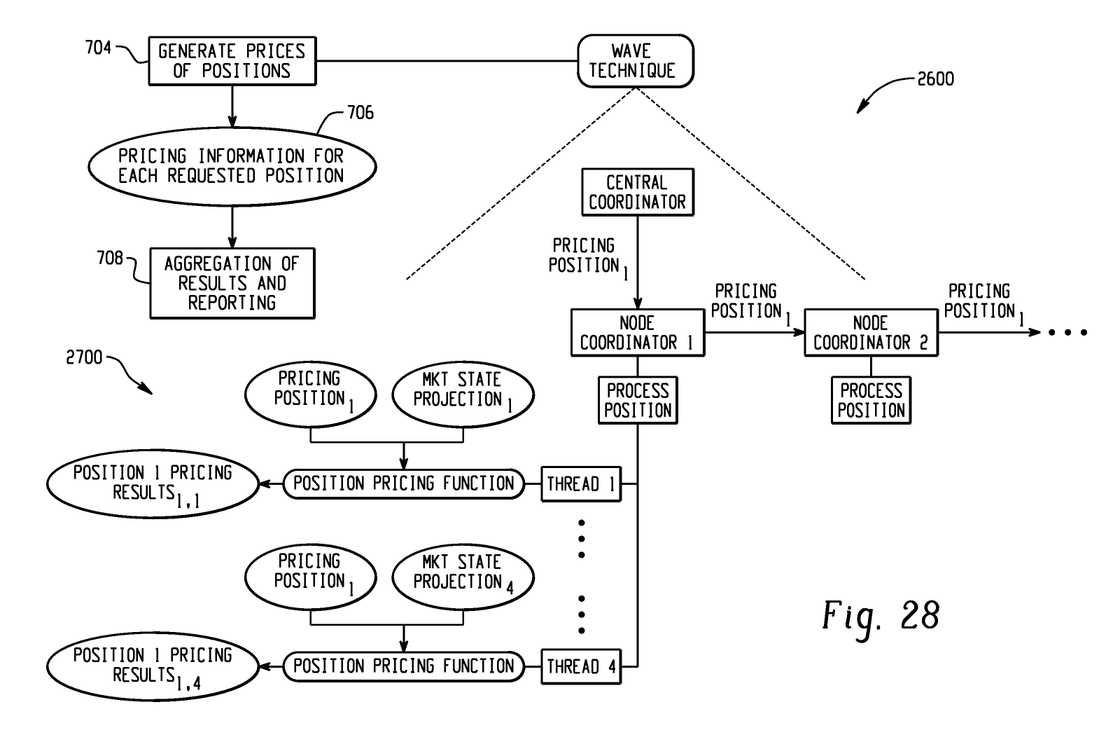

In FIG. 28, a first position is shown being distributed among the node coordinators. The positions are processed, such that each thread of a node coordinator applies a different market state projection to the first position than another thread. For example, FIG. 28 depicts at 2700 thread 1 of node 1 applying a position pricing function to the first market state projection and the first position to generate its pricing results. Concurrently, thread 4 of node 1 is applying a position pricing function to the fourth market state projection and the first position to generate its pricing results.

With respect to pricing functions, a client may provide in the position data for each type of instrument (e.g., a stock, a bond, a loan etc.) which pricing function should be used. For example, a Wall Street company can indicate how much a share of Chevron will be worth if the grid computing environment can provide information about the market state projections. Many different types of pricing functions can be used, such as those provided by FINCAD®. FINCAD® (which is located in Surrey, B.C., Canada) provides an analytics suite containing financial functions for pricing and measuring the risk of financial instruments.

The grid computing environment can be configured to map the stored risk factors to the pricing functions so that the pricing functions can execute. If needed, the grid computing environment can mathematically manipulate any data before it is provided as a parameter to a pricing function. In this way, the grid computing environment acts as the “glue” between the risk factors of the grid computing environment and the specific parameters of the pricing functions. For example, a pricing function may be called for a particular bond and calculates prices of positions based upon a set of parameters (e.g., parameters “a,” “b,” and “c”). The grid's risk factors are directly or indirectly mapped to the parameters of the pricing function. A system risk factor may map directly to parameter “a,” while a different system risk factor may need to be mathematically manipulated before it can be mapped to parameter “b” of the pricing function.

The number of calls by the node coordinator to the pricing function may be quite large. For example, suppose there are 1,000,000 positions and 10,000 market state projections. The overall number of pricing calls by the node coordinators will be 1,000,000 times 10,000 calls (i.e., 10,000,000,000).

A pricing function can provide many different types of outputs. For example, a pricing function can provide an array of output values and the grid computing environment can select which of the outputs is most relevant to a user's question. The output values can include for a bond pricing-related function what is the price of my bond, what is the exposure of my bond, etc.

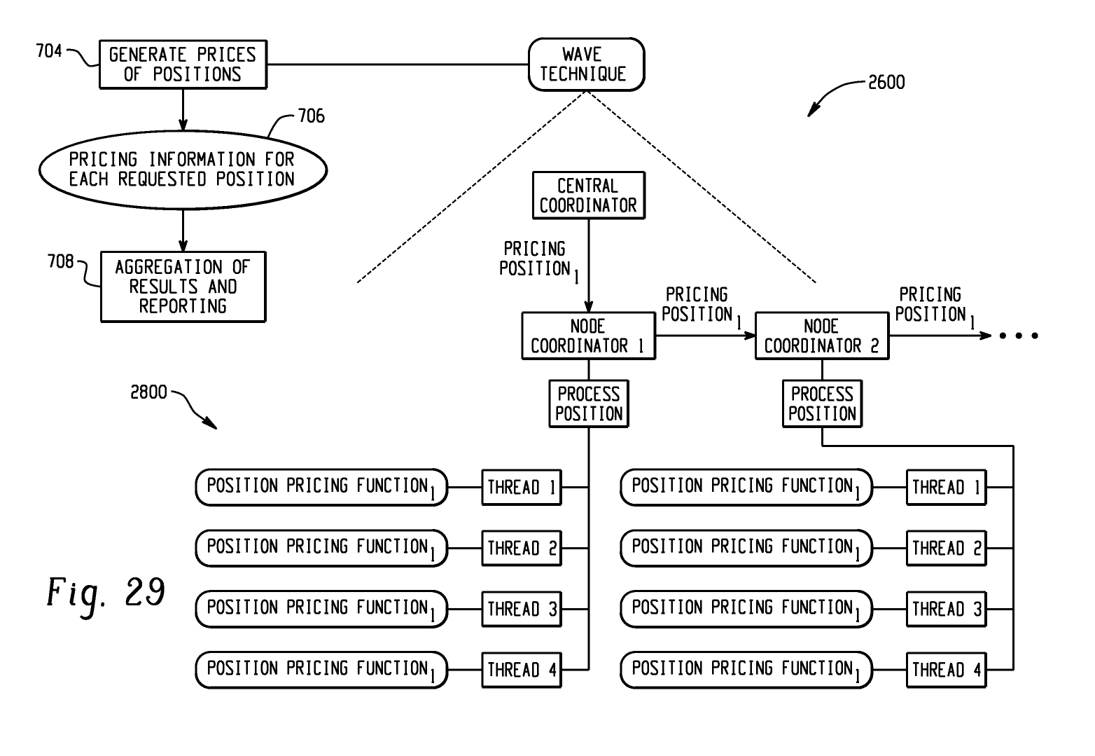

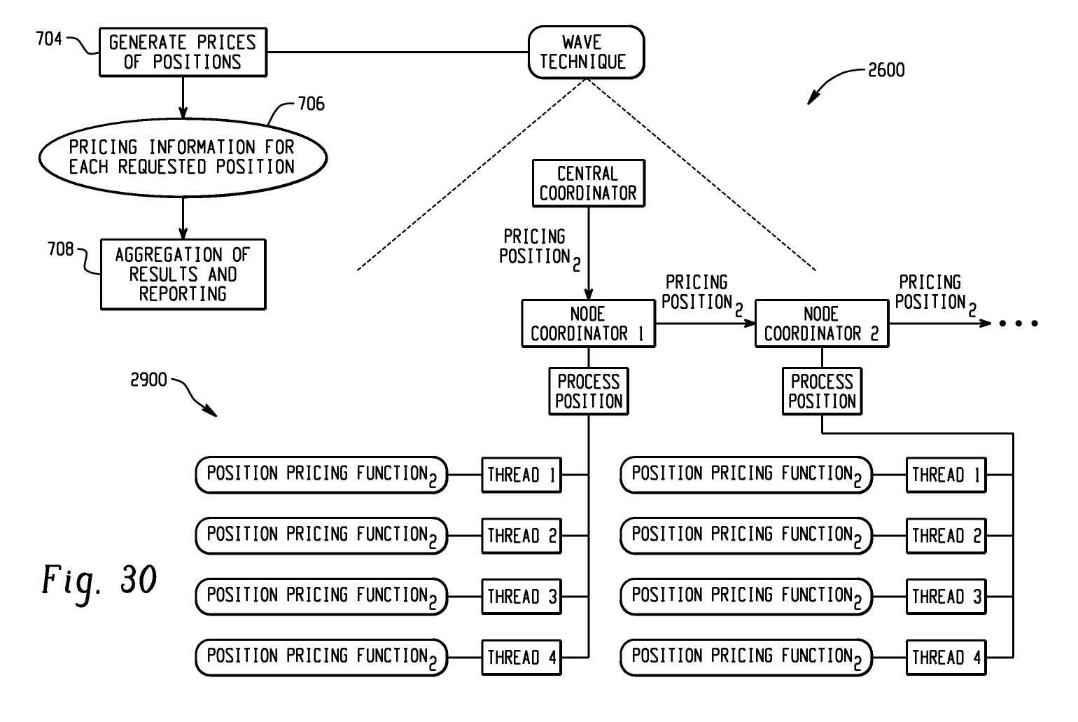

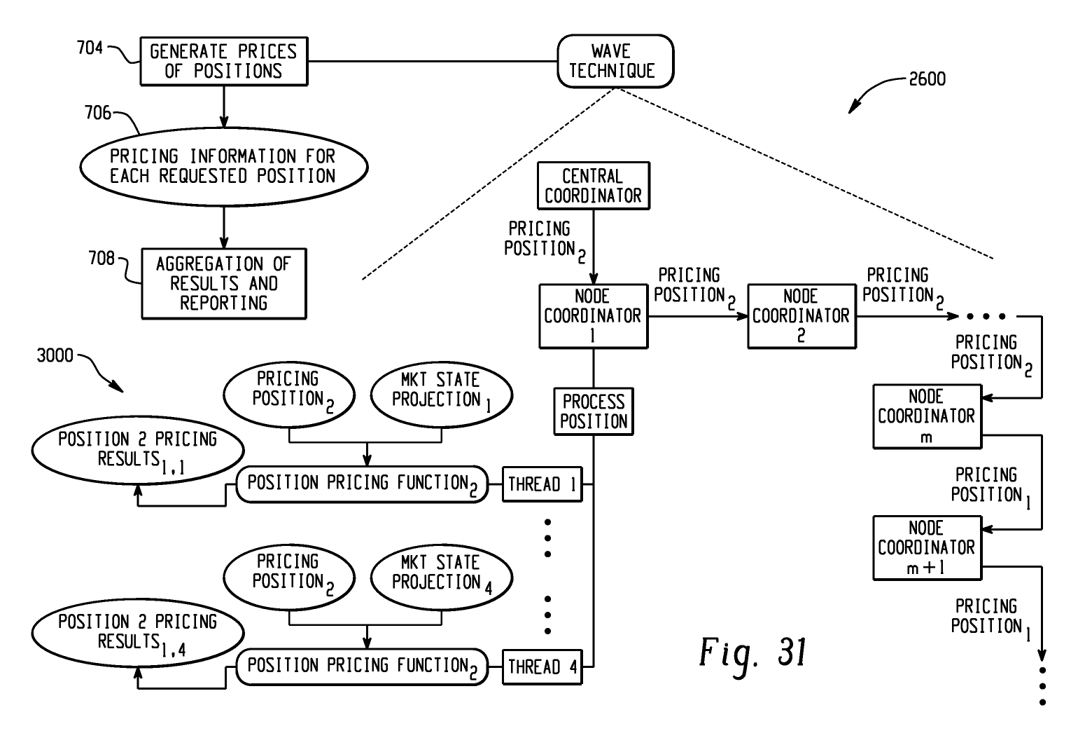

FIGS. 29 and 30 illustrate that different pricing functions can be used by the nodes depending upon the position the threads of the nodes are processing. As depicted at 2800, FIG. 29 shows that a first pricing function is used by the threads of nodes 1 and 2 when processing the first position. FIG. 30 depicts at 2900 that a second (e.g., different) pricing function is used by the threads of nodes when processing the second position. Although, FIGS. 29 and 30 depict nodes 1 and 2 processing the same positions, it should be understood that one or more nodes may be processing different positions than the positions that other nodes are currently processing. Such a situation is illustrated at 3000 in FIG. 31, wherein because of the position distribution technique, one or more nodes may be processing a position, while nodes earlier in the chain are processing positions that have just been provided to the first node by the central coordinator. As shown in FIG. 31, the central coordinator has provided the second position to the first node. However, the first position is still being processed by nodes further down the chain (i.e., nodes m, m+1, etc.). Accordingly, the threads of node 1 will be applying the second pricing function because it is processing the second position, while the threads of node m will be applying the first pricing function because it is still processing the first position.

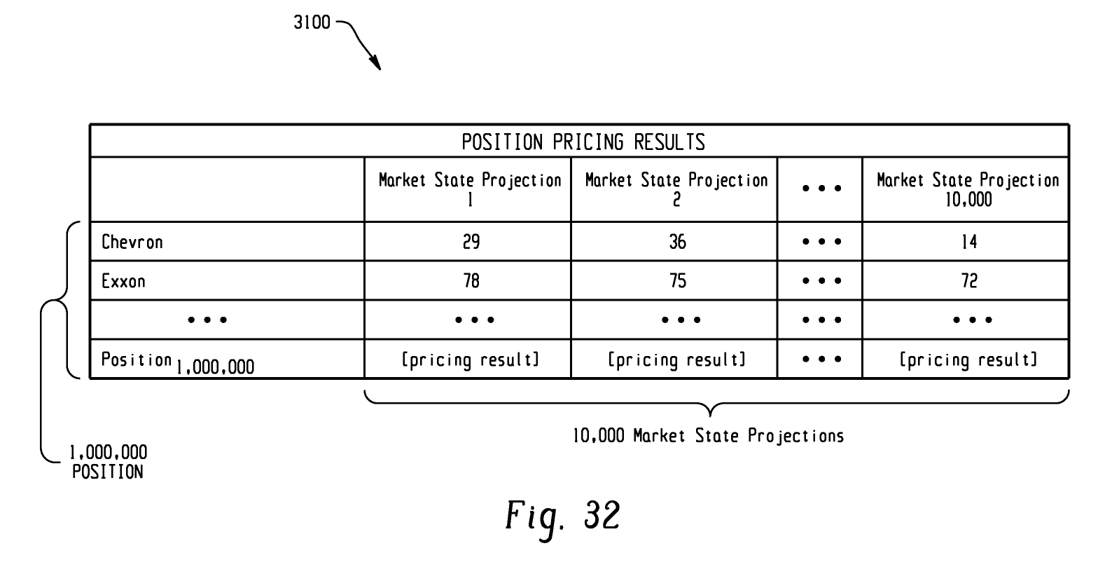

FIG. 32 depicts at 3100 an example of position pricing results. As shown in this figure, Chevron stock is at $29 per share as a price for a position in the first market state projection, $36 a share in the second market projection, . . . , and priced at $14 a share for the last market state projection. In other words these are possible prices for all of the possible market states.

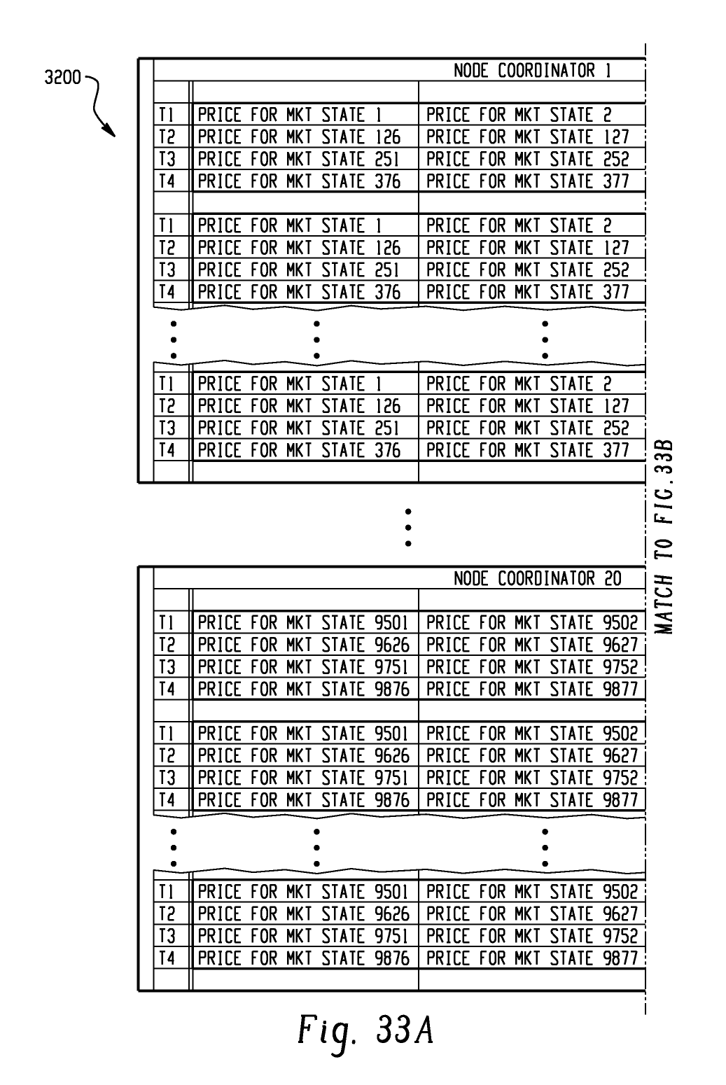

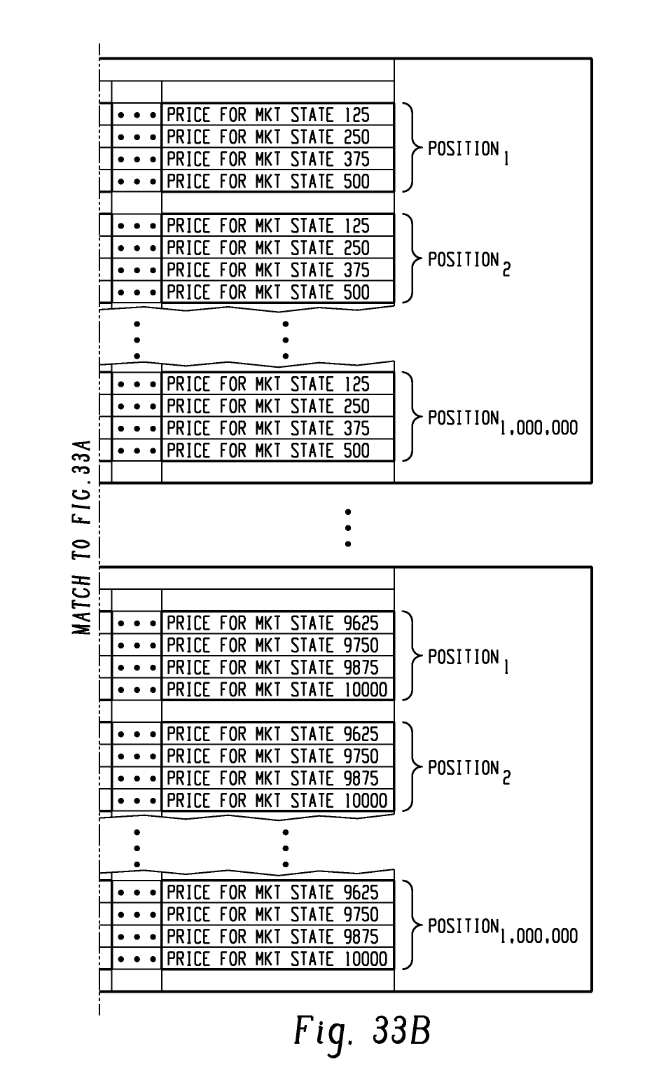

Each node coordinator maintains all of its pricing information results in its memory and optionally writes to a file in case a different user would like to access the results. Upon request by the central coordinator, each node coordinator sends its pricing information to the central coordinator for further processing. An example of node coordinators storing the pricing results are shown at 3200 in FIG. 33. As illustrated in this figure, the position pricing results are distributed among the various node coordinators. More specifically, each node coordinator contains position pricing results for all positions and for the market state projections for which it is responsible. In this example, there are 10,000 market state projections and 20 nodes having 4 threads per node. Accordingly, each node is responsible for 500 market state projections (i.e., (10,000 total market state projections)/(20 nodes)). With this apportionment, node coordinator 1 is responsible for the first 500 of the 10,000 total market states projections, node coordinator 2 is responsible for the next 500 market state projections, etc. Within a node, each thread is provided a pro rata share of the market state projections (e.g., 125 market state projections per thread). This figure illustrates an embodiment where thread 1 (T1) of node coordinator 1 handles the first set of market state projections, thread 2 (T2) of node coordinator handles the second set of market state projections, etc. It should be understood that other approaches can be used, such as T1 of node coordinator 1 handling the first market state projection, T2 of node coordinator 1 handling the second market state projection, etc.

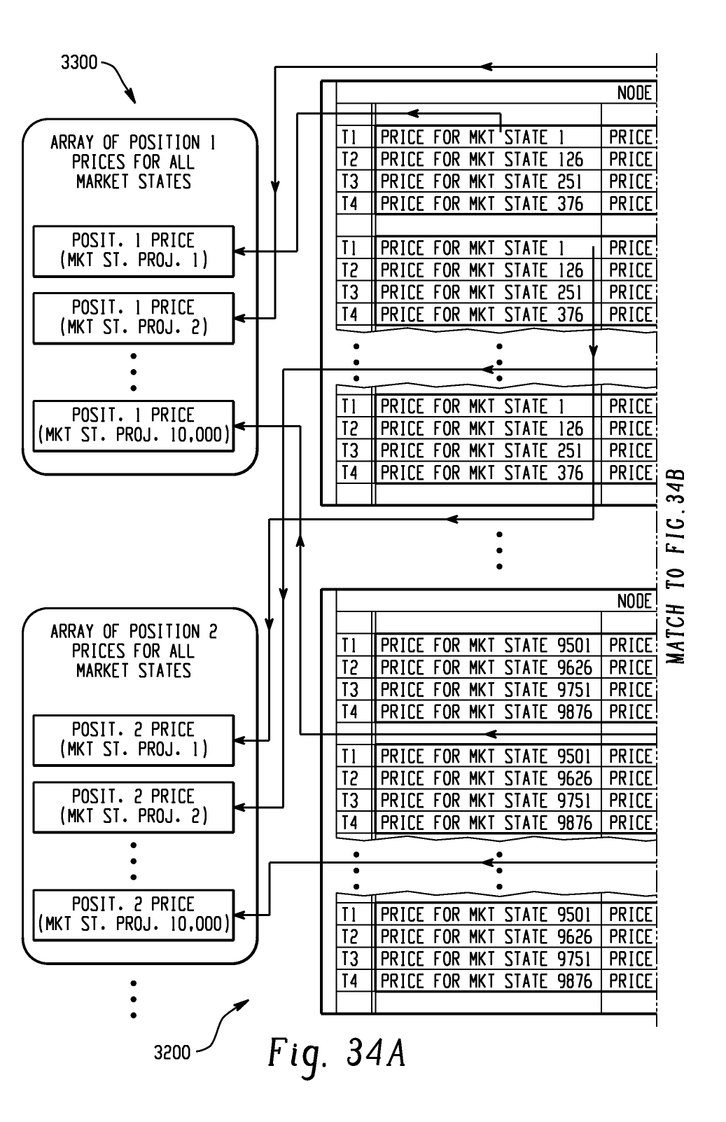

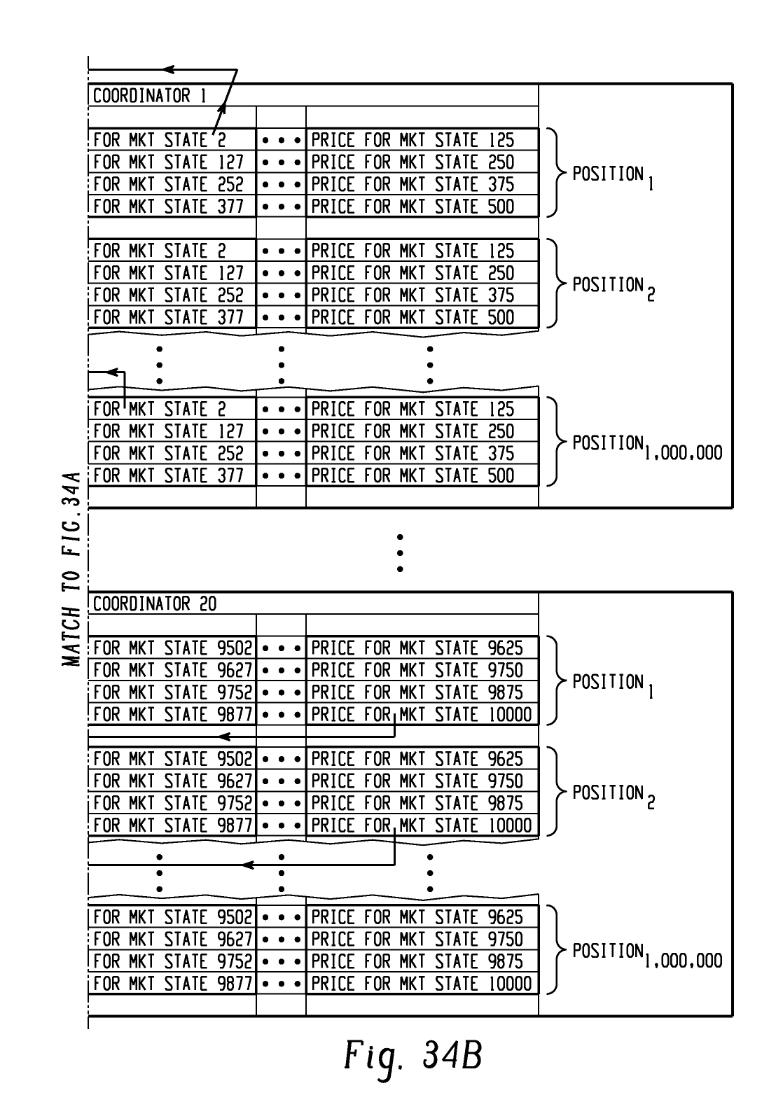

FIG. 34 depicts at 3300 an example of an array of position pricing results derived from the data stored at the node coordinators. This array of information is what will be aggregated by the central coordinator when it responds to a user's query.

This figure also illustrates the degree to which memory reconfiguration occurs at the node coordinators from when they generate the X′X matrix, the L′ matrix, the market state projections, and the position pricing results. The node coordinators change their node memory layouts as they generate each of the aforementioned data. Upon the final reconfiguration of the memory by each node coordinator, the user can then query (indirectly through the central coordinator) against the position pricing results which are stored at the node coordinators.

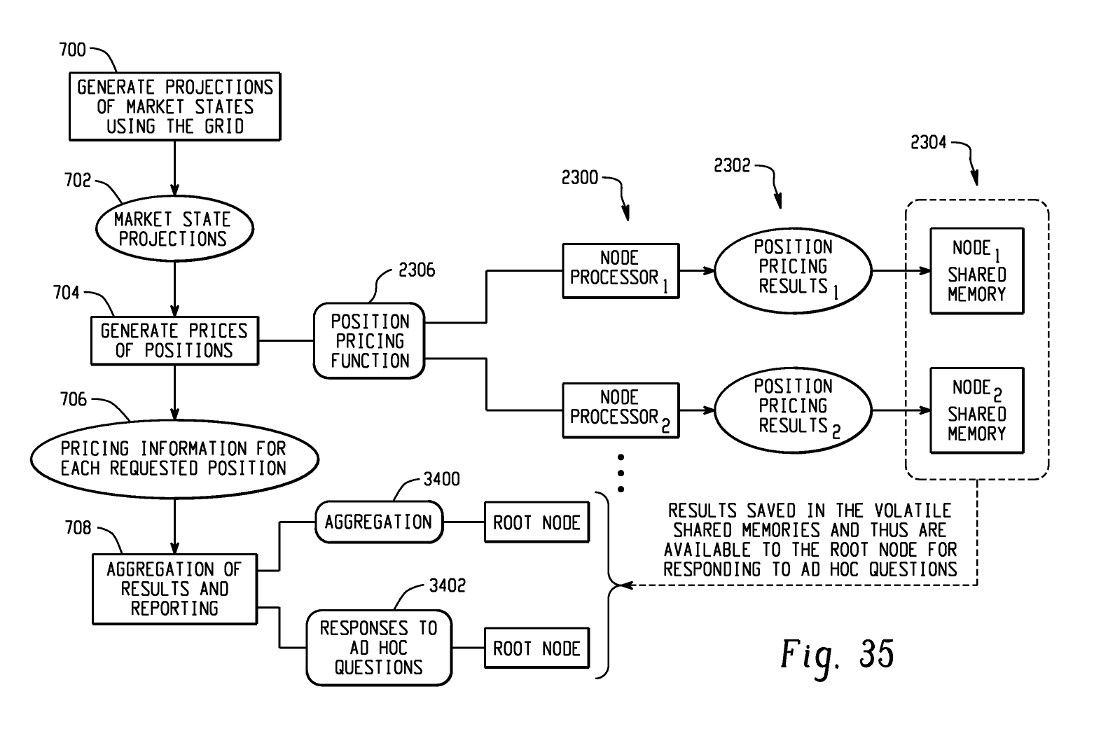

As illustrated in FIG. 35, the information at the node coordinators is retained in memory 2304 throughout the multiple steps to the extent that it is by the root node for aggregation 3400 in order to provide answers 3402 at different levels to the user. For example, as soon as the grid computing environment has completed calculating the market state projections, the previous intermediate results do not need to be retained in memory because they are not needed to handle a user's ad hoc queries. As another example, as soon as the Cholesky root is used to generate the market states, it is not retained beyond the immediate step and that memory can be freed up and reconfigured.

As noted above, position pricing results are retained in memory after they are created. The ability to do this entirely within memory without a requirement to writing it to disk can yield advantages within certain contexts. For example, the grid computing environment can be processing sensitive financial information which may be subject to regulations on preserving the confidentiality of the information. Because the sensitive financial information is only retained within memory, security regulations about sensitive financial data and their storage on nonvolatile storage medium are not implicated. Additionally, the user queries against pricing information which is stored in memory; after the querying process has completed, the information is removed from volatile memory at the end of the session. Accordingly in this example, information is not stored to disk, thereby eliminating or significantly reducing risk of a security breach. However, it should be understood that various other storage approaches can be utilized to suit the situation at hand, such as storing in non-volatile memory position pricing information for use at a later time. This can be helpful if a user would like to resume a session that had occurred several weeks ago or to allow another user (who has been authorized) to access the position pricing information.

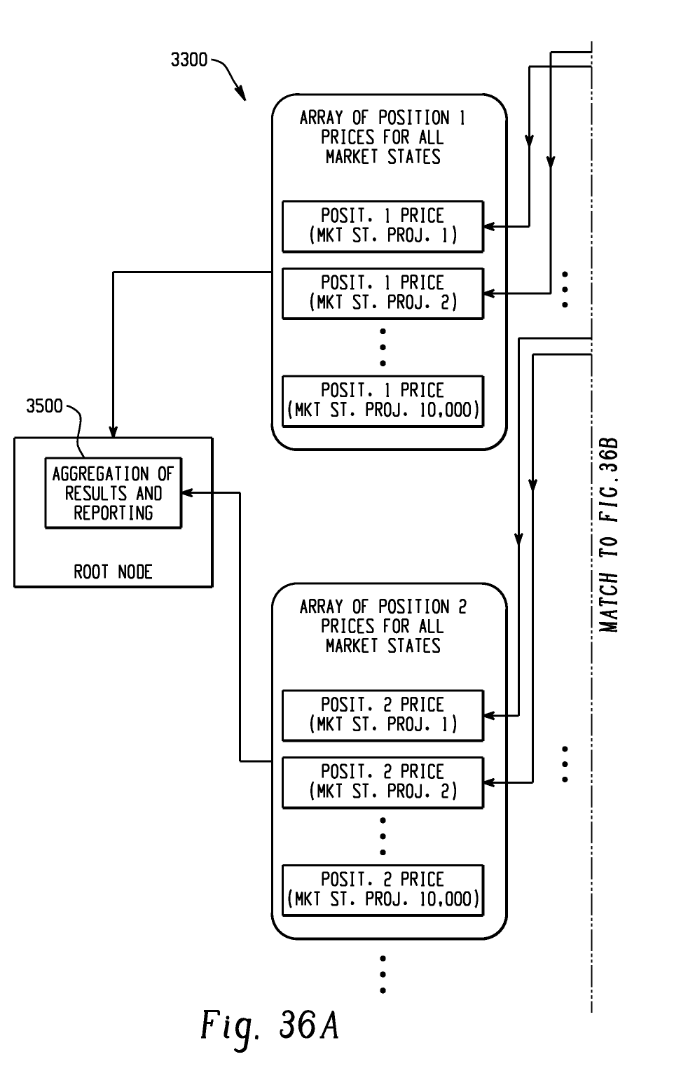

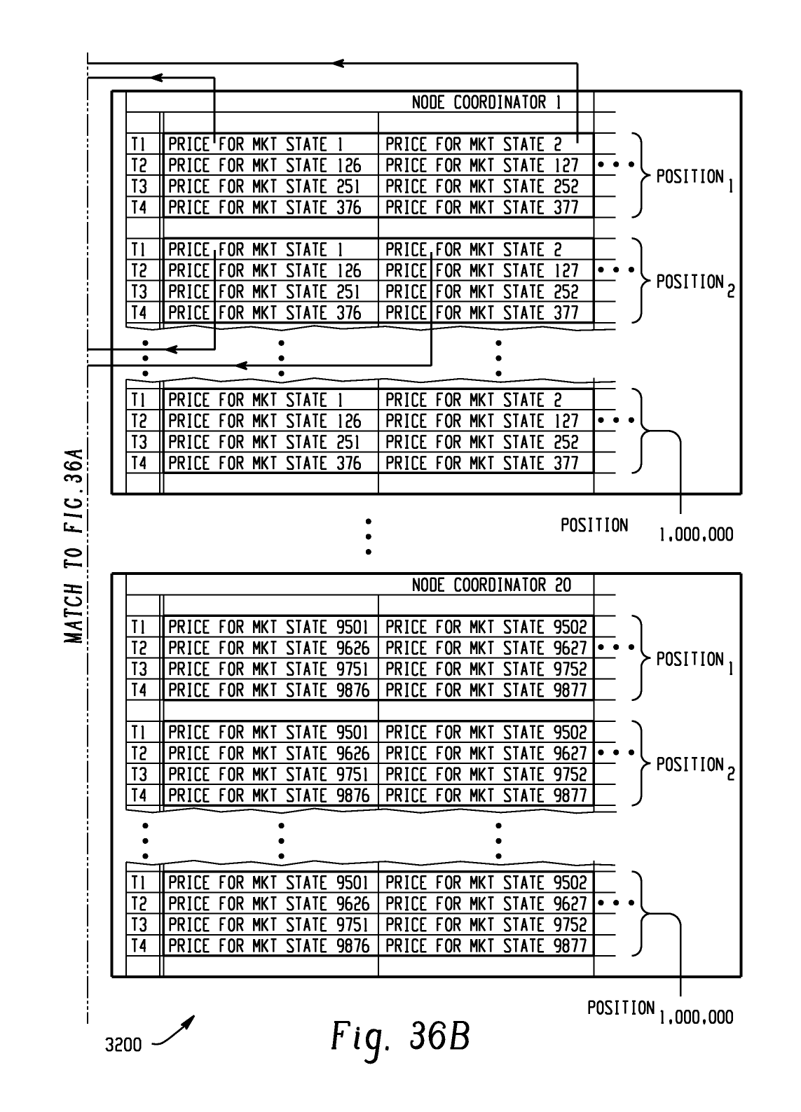

FIG. 36 depicts at 3500 functionality directed to aggregating results from the node coordinators and using the results to respond to ad hoc user queries. The central coordinator receives the individual position pricing results from each node coordinator. The central coordinator aggregates the position pricing results at a level which answers the query from the user. The central coordinator may also perform additional mathematical operations (e.g., descriptive statistical operations) on the aggregated data before forming the query response based upon the processed data. After a query is processed, the central coordinator is ready to receive another user query, and provide a response which is based upon the detailed position pricing results that are stored at the node coordinators.

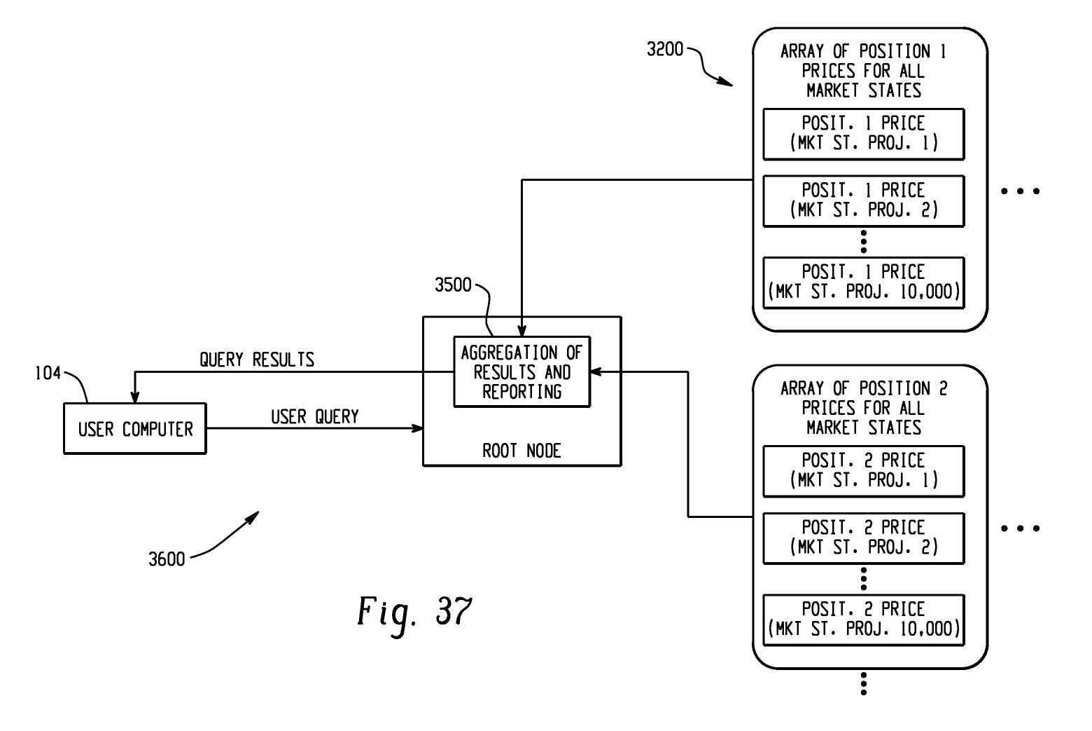

With respect to the aggregation of results from the node coordinators, FIG. 37 depicts at 3600 how the array of price positions as generated by the node coordinators are used by the central coordinator for aggregation of results and reporting purposes. The central coordinator performs a roll up of the information stored at the various root nodes and if needed, performs any descriptive statistics for responding to a query from a user.

As an illustration, consider a situation wherein all of the node coordinators have Google and Microsoft stock information, and the first node coordinator has position information for the first 1000 market state projections. The first node coordinator sends its Google and Microsoft position pricing results for its market state projections to the central coordinator for aggregation. Similarly, the other node coordinators send to the central coordinator its Google and Microsoft position pricing results for their respective market state projections. The central coordinator will join these sets to satisfy the user query. (It is noted that each node coordinator (in parallel with the other node coordinators) also performs its own form of aggregation upon the position pricing information received from its respective threads.) In short, because the underlying originally generated data is continuously stored either in memory or on disk, the central coordinator can answer ad hoc user queries at any level. This obviates the requirement that a grid must know the query before generating the market state projections and position pricing.

The central coordinator can be configured to retain the last query and its results in memory so that if the last query's results are relevant to a subsequent query, then such results can be used to handle that subsequent query. This removes the need to have to retrieve information from the node coordinators to handle the subsequent query. A central coordinator could be configured to discard a query's results if a subsequent query does not map into the most recent query. In this approach, the central coordinator would retrieve position pricing results from the node coordinators in order to satisfy the most recent query.

The query results sent back to the client can be used in many different ways, such as stored in a database at the client location, displayed on a graphical user interface, processed further for additional analysis, etc.

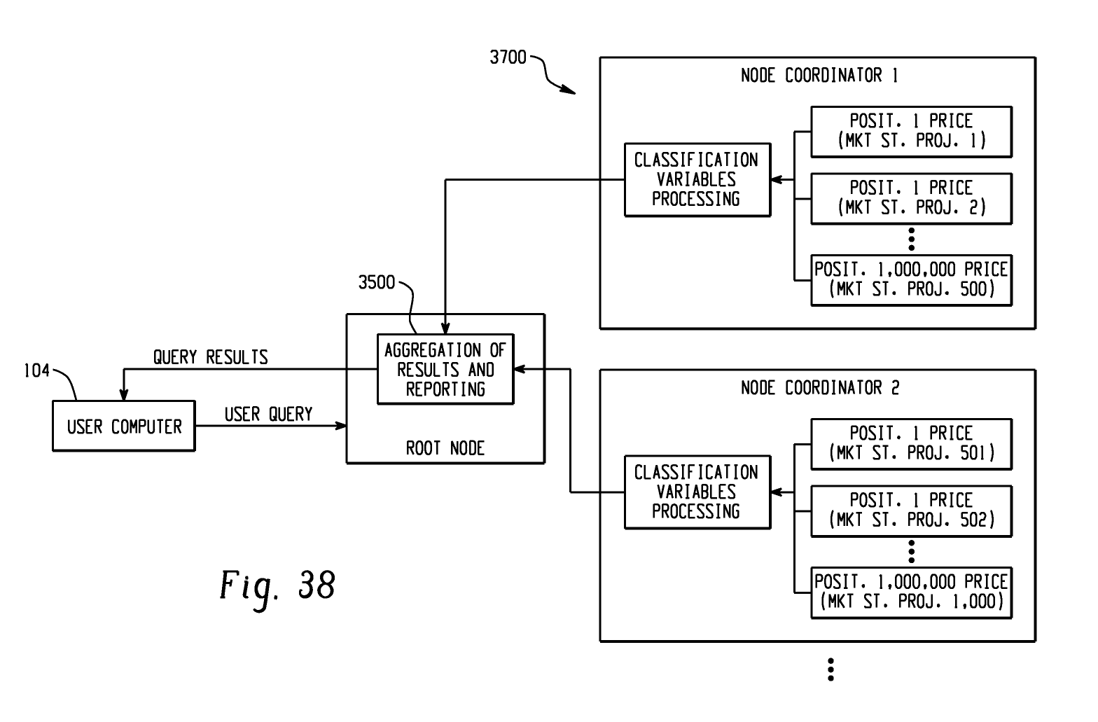

FIG. 38 depicts at 3700 classification variable processing being performed at the node coordinators in order to provide query results to a user computer. As part of the position pricing information, classification variables are used to identify certain data items that the user might want to query upon (e.g., querying criteria). For example, a classification variable might be geography. Using the geography classification variable, a user can examine position pricing information at a state level versus a national level. As another example, a classification variable might be industry sector, by which a user might want to examine position pricing information of the computer industry in general or might want to drill down and examine position information associated with specific companies in the computer industry.

To assist in the classification variable processing, the node coordinators associate levels to the values within their respective position pricing data. The node coordinators keep track that each position is associated with a particular level of a classification variable. Accordingly during the querying phase, a user query may indicate that the client wishes to have an accumulation based upon a particular classification variable and to be provided with descriptive statistics associated with that classification variable or a combination of the classification variables (e.g., cross-classification of variables, such as for this region provide a company-by-company breakdown analysis). The central coordinator receives from the node coordinators their respectively processed data and aggregates them.

If the user prefers information at a higher level for a query, then the node coordinators aggregate their respective detailed pricing information to satisfy the first query. If the user provides a second query which is at a level of greater detail, then the node coordinators aggregate their detailed pricing information at the more detailed level to satisfy the second query. At these different levels, a user can learn whether they are gaining or losing money.

For example, the user can learn that the user has a higher level or risk of losing money in the computer industry sector, but only a low risk of losing money in a different industry sector. The user can then ask to see greater detail about which specific companies are losing money for the user within the computer industry. Upon receiving this subsequent query, the node coordinators process the position pricing data associated the industry sector classification variable at a lower level of detail than the initial query which was at a higher industry sector level.

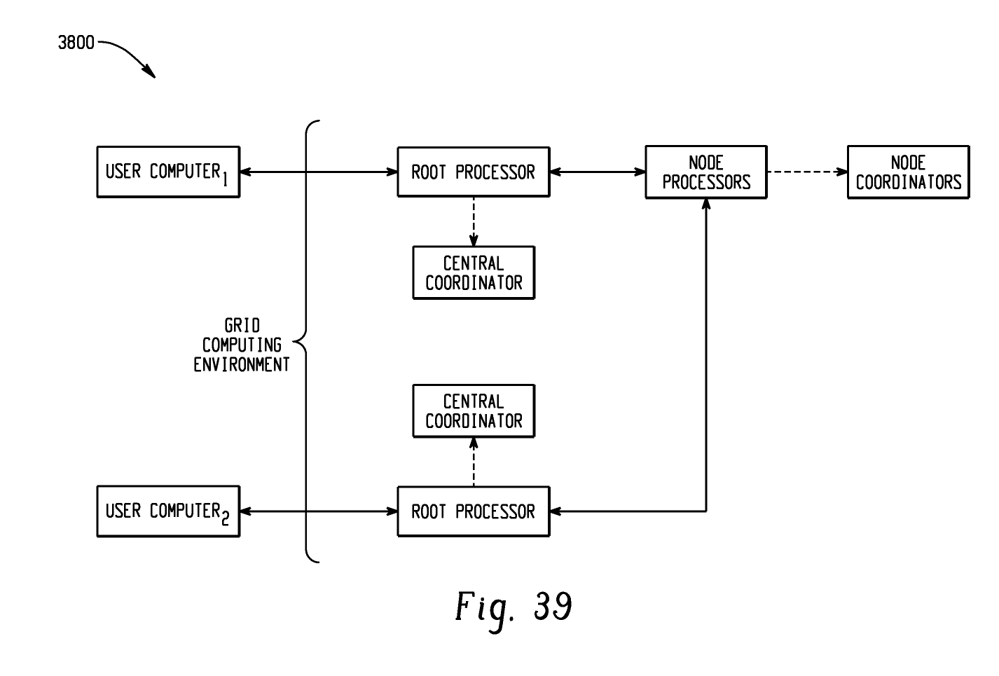

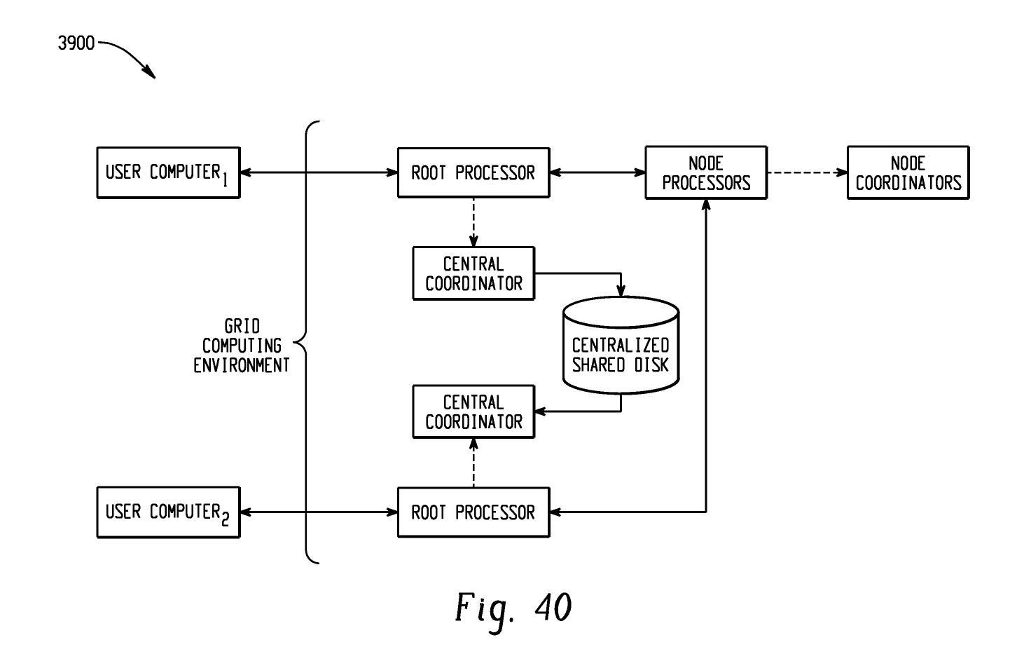

FIG. 39 depicts at 3800 a multi-user environment involving the grid computing environment. In such an environment, each user will receive its own central coordinator to handle its own queries and its own node coordinators. As shown at 3900 in FIG. 40, if another user is authorized to access the pricing information results of another user, then the second central coordinator can access the position pricing results of the first user. This can be facilitated if the results of the first user have been written to files. In this situation, the second user's central coordinator accesses the position pricing information files to handle queries from the second user. It should be understood, that approaches for handling multi-user querying could include avoiding writing the information to non-volatile memory, but instead maintaining it in volatile memory of the grid and allowing the other user to access such content through its respective central coordinators.

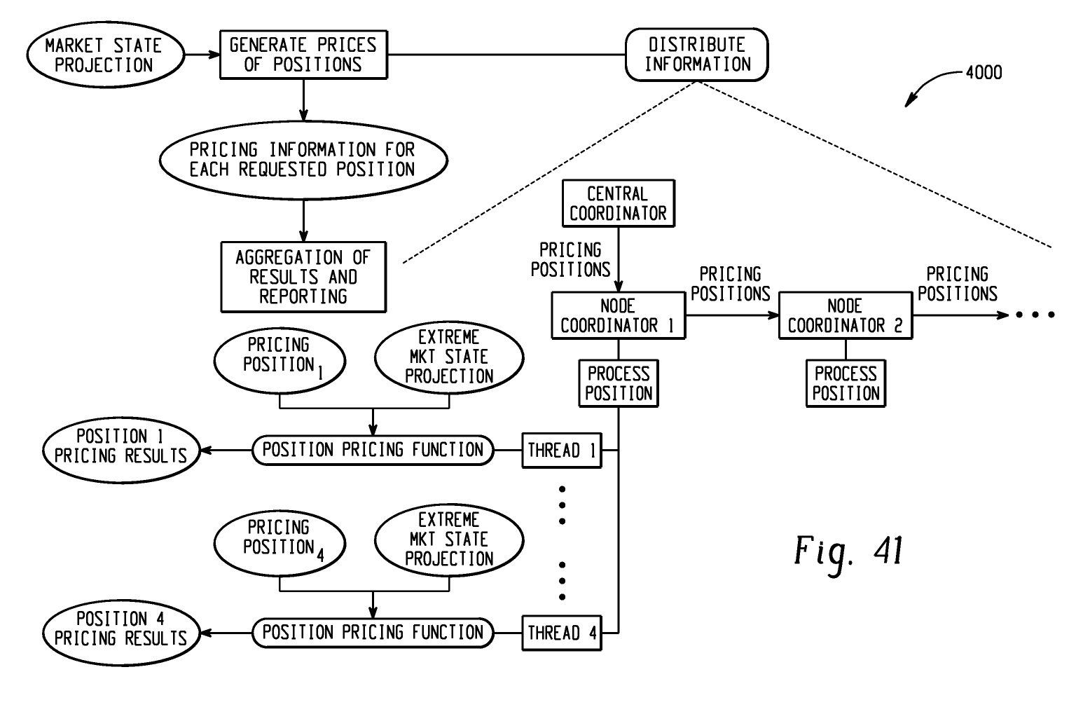

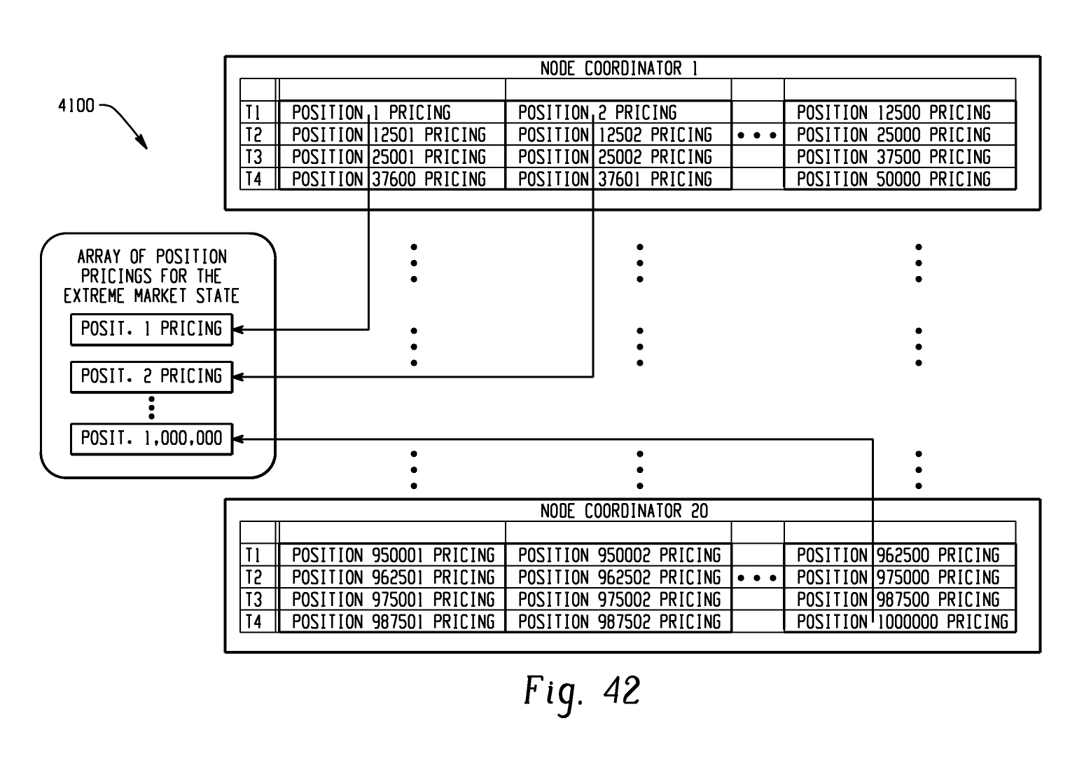

This written description uses examples to disclose the invention, including the best mode, and also to enable a person skilled in the art to make and use the invention. The patentable scope of the invention may include other examples. For example, the systems and methods described herein may be used for market stress testing purposes as shown in FIG. 41. determine the stability of a given system or entity. Market stress testing involves examining a market state projection that is beyond normal operational capacity, often to a breaking point, and analyzing the position pricing results. As shown at 4000 in FIG. 41, the grid computing environment processes only one market state projection for the positions requested by a user. The extreme market state projection and the different positions are distributed by the central coordinator to the node coordinators. Each thread of a node coordinator examines a different position with respect to the same market state projection. The results of each thread are stored in the shared memory of its respective node. The central coordinator can then aggregate the results to satisfy user queries. It is noted that the non-stress testing examples described herein provides that each of the nodes processes the same positions, but for different market state projections. In the stress testing approach depicted in FIG. 41, each of the nodes processes the same market state project, but for different positions. This difference is further illustrated in the manner in which each node stores its results. FIG. 42 depicts at 4100 that the stress testing results are stored at each node. In this example, there 1,000,000 positions and 1 market state projection. If there are 20 nodes, then each node will process 50,0000 positions for the 1 market state projection. Accordingly, each node will store 50,000 position pricings. Still further, if there are 4 threads per node, then each thread will handle 12,5000 positions and will correspondingly store 12,500 position pricings.

The examples of FIGS. 41 and 42 can perform stress testing in many different types of applications, such as to examine how stocks, bonds, or other types of financial instruments might react in certain crash scenarios, such as:
What happens if oil prices rise by 200%?
What happens if unemployment reaches 10%?
What happens if the market crashes by more than x % this year?
What happens if interest rates go up by at least y %?

As another example of the wide scope of the systems and methods disclosed herein, the systems and methods may include data signals conveyed via networks (e.g., local area network, wide area network, internet, combinations thereof, etc.), fiber optic medium, carrier waves, wireless networks, etc. for communication with one or more data processing devices. The data signals can carry any or all of the data disclosed herein that is provided to or from a device.

As another example of the wide scope of the systems and methods disclosed herein, it should be understood that the techniques disclosed herein are not limited to risk pricing, but can also include any type of problem that involve large data sets and matrix decomposition. As another example, it should be understood that a configuration can be used such that a conventional approach is used to generate market state projections (e.g., through use of the SAS Risk Dimensions product), but the position pricing approaches disclosed herein are used. Correspondingly, a configuration can be used such that the market state generation approach as disclosed herein can provide output to a conventional position pricing application.

Additionally, the methods and systems described herein may be implemented on many different types of processing devices by program code comprising program instructions that are executable by the device processing subsystem. The software program instructions may include source code, object code, machine code, or any other stored data that is operable to cause a processing system to perform the methods and operations described herein. Other implementations may also be used, however, such as firmware or even appropriately designed hardware configured to carry out the methods and systems described herein.

The systems' and methods' data (e.g., associations, mappings, data input, data output, intermediate data results, final data results, etc.) may be stored and implemented in one or more different types of computer-implemented data stores, such as different types of storage devices and programming constructs (e.g., RAM, ROM, Flash memory, flat files, databases, programming data structures, programming variables, IF-THEN (or similar type) statement constructs, etc.). It is noted that data structures describe formats for use in organizing and storing data in databases, programs, memory, or other computer-readable media for use by a computer program.

The computer components, software modules, functions, data stores and data structures described herein may be connected directly or indirectly to each other in order to allow the flow of data needed for their operations. It is also noted that a module or processor includes but is not limited to a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

It should be understood that as used in the description herein and throughout the claims that follow, the meaning of “a,” “an,” and “the” includes plural reference unless the context clearly dictates otherwise. Also, as used in the description herein and throughout the claims that follow, the meaning of “in” includes “in” and “on” unless the context clearly dictates otherwise. Finally, as used in the description herein and throughout the claims that follow, the meanings of “and” and “or” include both the conjunctive and disjunctive and may be used interchangeably unless the context expressly dictates otherwise; the phrase “exclusive or” may be used to indicate situation where only the disjunctive meaning may apply.

It is claimed:

1. A grid computing system having multiple data processors for generating multiple system state projections for a scenario defined at least in part by a coefficients matrix (A), the system comprising:
a central coordinator software component executing on a root data processor for providing commands and data to a plurality of node coordinator software components;
each of the plurality of node coordinator software components being associated with and executing on separate node data processors, each node data processor having a volatile computer memory for access by the node coordinator software component and for access by threads executing on the node data processor;
each of the node coordinator software components being configured to:
manage threads which execute on its associated node data processor and which perform a set of matrix operations with respect to the coefficients matrix (A), wherein stochastic simulations use results of the matrix operations to generate multiple state projections;
manage the threads which execute on its associated node data processor and which perform a portion of scenario evaluations based upon the state projections and based upon scenario information provided by a user computer, thereby generating scenario evaluation results;
the volatile computer memory of a node data processor retaining the results of the scenario evaluations that were performed at the node data processor;
the central coordinator software component being configured to receive ad hoc questions from the user computer and provide responses to the ad hoc questions by aggregating and concatenating the scenario evaluation results provided by each of the node data processors;
wherein the central coordinator software component processes the ad hoc questions from the user computer by instructing the node coordinator software component to access and process the results of the scenario evaluations that are stored in the volatile memory of its associated node data processor.

2. The system of claim 1, wherein a node data processor includes a multi-core processor.

3. The system of claim 2, wherein the multi-core processor implements multiprocessing in a single physical package.

4. The system of claim 2, wherein the multi-core processor comprises a dual-core processor, wherein each node coordinator software component is associated with a dual-core processor for managing thread execution on the associated dual-core processor; wherein a thread executes on a core processor of the associated dual-core processor.

5. The system of claim 1, wherein the central coordinator software component comprises a set of instructions for execution on the root data processor and for providing commands to the node coordinator software components.

6. The system of claim 1, wherein the matrix (A) is a symmetric matrix.

7. The system of claim 1, wherein the central coordinator software component executing on the root concatenates the results of the scenario evaluations performed at the node data processors.

8. The system of claim 1, wherein the root data processor includes a random number generator for generating a series of random numbers;
wherein the central coordinator software component distributes the generated series of random numbers to the node coordinator software components for use in generating multiple state projections.

9. The system of claim 1, wherein said performing of stochastic simulations includes generating projections of states based upon a history of risk factors.

10. The system of claim 1, wherein the central coordinator software component provides a first row of data to a first node coordinator software component; wherein the first node coordinator software component sends the first row of data to a second node coordinator and then the first node coordinator software component has the first row of data processed for use in the matrix operations;
said processing of the first row of data including the first node coordinator software component instructing its threads to read the first row of data so that the threads can construct an upper triangular portion of the matrix (A);
wherein other node coordinator software components instruct their respective threads to read a row of data provided by another node coordinator software component so that the threads can construct their respective portions of the upper triangular portion of the matrix (A).

11. The system of claim 1, wherein the scenario information provided by the user computer includes positions.

12. The system of claim 1, wherein the central coordinator software component further processes the ad hoc questions from the user computer by instructing the node coordinator software component to access and process the results of state projection operations that are stored in the volatile memory of its associated node data processor.

13. The system of claim 1, wherein the volatile computer memory of a node data processor being reformatted in order to reuse same volatile computer memory in the scenario evaluations that was used in the state generation operations.

14. A method for a grid computing system having multiple data processors for generating multiple system state projections for a scenario defined at least in part by a coefficients matrix (A), the method comprising:
executing on a root data processor a central coordinator software component for providing commands and data to a plurality of node coordinator software components;
executing on separate node data processors the plurality of node coordinator software components, each node data processor having a volatile computer memory for access by the node coordinator software component and for access by threads executing on the node data processor;
each of the node coordinator software components:
managing threads which execute on its associated node data processor and which perform a set of matrix operations with respect to the coefficients matrix (A), wherein stochastic simulations use results of the matrix operations to generate multiple state projections;
managing the threads which execute on its associated node data processor and which perform a portion of scenario evaluations based upon the state projections and based upon scenario information provided by a user computer, thereby generating scenario evaluation results;
the volatile computer memory of a node data processor retaining the results of the scenario evaluations that were performed at the node data processor;
the central coordinator software component receiving ad hoc questions from the user computer and provide responses to the ad hoc questions by aggregating and concatenating the scenario evaluation results provided by each of the node data processors;
wherein the central coordinator software component processes the ad hoc questions from the user computer by instructing the node coordinator software component to access and process the results of the scenario evaluations that are stored in the volatile memory of its associated node data processor.

15. A grid computing system having multiple data processors for generating multiple system state projections for a scenario defined at least in part by a coefficients matrix (A), the system comprising:
a central coordinator software component executing on a root data processor for providing commands and data to a plurality of node coordinator software components;
each of the plurality of node coordinator software components being associated with and executing on separate node data processors, each node data processor having a volatile computer memory for access by the node coordinator software component and for access by threads executing on the node data processor;
each of the node coordinator software components being configured to generate the multiple state projections by:
the central coordinator software component providing a first row of data to a first node coordinator software component;
the first node coordinator software component sending the first row of data to a second node coordinator and then the first node coordinator software component has the first row of data processed for use in the matrix operations;
said processing of the first row of data including the first node coordinator software component instructing its threads to read the first row of data so that the threads can construct an upper triangular portion of the matrix (A);
other node coordinator software components instructing their respective threads to read a row of data provided by another node coordinator software component so that the threads can construct their respective portions of the upper triangular portion of the matrix (A);
stochastic simulations being executed based upon the constructed portions of the upper triangular portion of the matrix (A) to generate multiple state projections for storage by the node coordinators.

16. The system of claim 15, wherein the threads, which execute on their associated node data processors, perform scenario evaluations based upon the state projections and based upon scenario information provided by a user computer, thereby generating scenario evaluation results.

17. The system of claim 16, wherein the volatile computer memory of a node data processor retains the results of the scenario evaluations that were performed at the node data processor.

18. The system of claim 17, wherein the central coordinator software component is configured to receive ad hoc questions from the user computer and provide responses to the ad hoc questions by aggregating and concatenating the scenario evaluation results provided by each of the node data processors;
wherein the central coordinator software component processes the ad hoc questions from the user computer by instructing the node coordinator software component to access and process the results of the scenario evaluations that are stored in the volatile memory of its associated node data processor.

19. The system of claim 18, wherein the central coordinator software component executing on the root concatenates the results of the scenario evaluations performed at the node data processors.

20. The system of claim 19, wherein the central coordinator software component further processes the ad hoc questions from the user computer by instructing the node coordinator software component to access and process the results of state projection operations that are stored in the volatile memory of its associated node data processor.

21. The system of claim 19, wherein the volatile computer memory of a node data processor being reformatted in order to reuse same volatile computer memory in the scenario evaluations that was used in the state generation operations.

22. The system of claim 15, wherein a node data processor includes a multi-core processor.

23. The system of claim 22, wherein the multi-core processor implements multiprocessing in a single physical package.

24. The system of claim 22, wherein the multi-core processor comprises a dual-core processor, wherein each node coordinator software component is associated with a dual-core processor for managing thread execution on the associated dual-core processor; wherein a thread executes on a core processor of the associated dual-core processor.

25. The system of claim 15, wherein the central coordinator software component comprises a set of instructions for execution on the root data processor and for providing commands to the node coordinator software components.

26. The system of claim 15, wherein the matrix (A) is a symmetric matrix.

27. The system of claim 15, wherein the root data processor includes a random number generator for generating a series of random numbers;
wherein the central coordinator software component distributes the generated series of random numbers to the node coordinator software components for use in generating multiple state projections.

28. The system of claim 15, wherein said performing of stochastic simulations includes generating projections of states based upon a history of risk factors.

29. A grid computing system having multiple data processors for scenario analysis using multiple system state projections, the system comprising:
a central coordinator software component executing on a root data processor for providing commands and data to a plurality of node coordinator software components;
each of the plurality of node coordinator software components being associated with and executing on separate node data processors, each node data processor having a volatile computer memory for access by the node coordinator software component and for access by threads executing on the node data processor;
each of the node coordinator software components being configured to:
manage the threads which execute on its associated node data processor and which perform a portion of scenario evaluations based upon the state projections and based upon scenario information provided by a user computer, thereby generating scenario evaluation results;
wherein, to generate the scenario evaluation results, a thread applies a different subset of system state projections than any other of the threads to a plurality of positions, wherein the positions represent attributes of items which are to be evaluated under the different scenarios of the system state projections;
the volatile computer memory of a node data processor retaining the results of the scenario evaluations that were performed at the node data processor;
the central coordinator software component being configured to receive ad hoc questions from the user computer and provide responses to the ad hoc questions by aggregating and concatenating the scenario evaluation results provided by each of the node data processors;
wherein the central coordinator software component processes the ad hoc questions from the user computer by instructing the node coordinator software component to access and process the results of the scenario evaluations that are stored in the volatile memory of its associated node data processor.

30. The system of claim 29, wherein a node data processor includes a multi-core processor.

31. The system of claim 30, wherein the multi-core processor implements multiprocessing in a single physical package.

32. The system of claim 30, wherein the multi-core processor comprises a dual-core processor, wherein each node coordinator software component is associated with a dual-core processor for managing thread execution on the associated dual-core processor; wherein a thread executes on a core processor of the associated dual-core processor.

33. The system of claim 29, wherein the central coordinator software component comprises a set of instructions for execution on the root data processor and for providing commands to the node coordinator software components.

34. The system of claim 29, wherein the central coordinator software component executing on the root concatenates the results of the scenario evaluations performed at the node data processors.

35. The system of claim 29, wherein the central coordinator software component distributes position data among the node data processors by providing a first position to a first node coordinator software component; wherein the first node coordinator software component sends the first position to a second node coordinator and then the first node coordinator software component has the first position processed with respect to state projections for which the first node coordinator software component is responsible.

36. The system of claim 29, wherein the items comprise investment vehicles;
wherein the attributes of the items comprise position information which is to be evaluated under different state projections;
wherein the positions are provided by the user computer.

37. The system of claim 29, wherein the central coordinator software component further processes the ad hoc questions from the user computer by instructing the node coordinator software component the position processing results that are stored in the volatile memory of its associated node data processor.

38. A grid computing system having multiple data processors for factorization of a matrix (A) into a pre-determined canonical form, the system comprising:
a central coordinator software component executing on a root data processor for providing commands and data to a plurality of node coordinator software components;
each of the plurality of node coordinator software components being associated with and executing on separate node data processors, each node data processor having a volatile computer memory for access by the node coordinator software component and for access by threads executing on the node data processor;
each of the node coordinator software components being configured to generate portions of the factorization of the matrix (A) by:
the central coordinator software component providing a first row of data from matrix (A) to a first node coordinator software component;
the first node coordinator software component sending the first row of data to a second node coordinator and then the first node coordinator software component has the first row of data processed;
said processing of the first row of data including the first node coordinator software component instructing its threads to read the first row of data so that the threads can construct a triangular portion of the matrix (A);
other node coordinator software components instructing their respective threads to read a row of data provided by another node coordinator software component so that the threads can construct their respective portions of the triangular portion of the matrix (A), thereby generating the factorization of the matrix (A).

39. The system of claim 38, wherein the factorization of matrix (A) comprises a Cholesky decomposition of matrix (A).

40. The system of claim 38, wherein the node coordinator software components are configured to execute stochastic simulations based upon the constructed portions of the triangular portion of the matrix (A).

41. The system of claim 40, wherein execution of the stochastic simulations generate multiple state projections.

42. The system of claim 41, wherein the root data processor includes a random number generator for generating a series of random numbers;
wherein the central coordinator software component distributes the generated series of random numbers to the node coordinator software components for use in generating multiple state projections.

43. The system of claim 42, wherein said performing of stochastic simulations includes generating projections of states based upon a history of risk factors.

44. The system of claim 41, wherein the threads, which execute on their associated node data processors, perform scenario evaluations based upon the state projections and based upon scenario information provided by a user computer, thereby generating scenario evaluation results.

45. The system of claim 44, wherein the volatile computer memory of a node data processor retains the results of the scenario evaluations that were performed at the node data processor.

46. The system of claim 45, wherein the central coordinator software component is configured to receive ad hoc questions from a user computer and provide responses to the ad hoc questions by aggregating and concatenating the scenario evaluation results provided by each of the node data processors;
wherein the central coordinator software component processes the ad hoc questions from the user computer by instructing the node coordinator software component to access and process the results of the scenario evaluations that are stored in the volatile memory of its associated node data processor.

47. The system of claim 46, wherein the central coordinator software component executing on the root concatenates the results of the scenario evaluations performed at the node data processors.

48. The system of claim 38, wherein a node data processor includes a multi-core processor.

49. The system of claim 48, wherein the multi-core processor implements multiprocessing in a single physical package.

50. The system of claim 48, wherein the multi-core processor comprises a dual-core processor, wherein each node coordinator software component is associated with a dual-core processor for managing thread execution on the associated dual-core processor; wherein a thread executes on a core processor of the associated dual-core processor.

51. The system of claim 38, wherein the central coordinator software component comprises a set of instructions for execution on the root data processor and for providing commands to the node coordinator software components.

52. The system of claim 38, wherein the matrix (A) is a symmetric matrix.

53. A grid computing system having multiple data processors for performing a stress test for a pre-specified, extreme state projection, the system comprising:
a central coordinator software component executing on a root data processor for providing commands and data to a plurality of node coordinator software components;
each of the plurality of node coordinator software components being associated with and executing on separate node data processors, each node data processor having a volatile computer memory for access by the node coordinator software component and for access by threads executing on the node data processor;
each of the node coordinator software components being configured to:
manage the threads which execute on its associated node data processor and which perform position evaluations based upon the extreme state projection and based upon position information provided by a user computer, thereby generating position evaluation results;
wherein each of the threads executing on the node data processors process the extreme state projection but process a different position;
the volatile computer memory of a node data processor retaining the results of the position evaluations that were performed at the node data processor;
the central coordinator software component being configured to receive ad hoc questions from the user computer and provide responses to the ad hoc questions by aggregating and concatenating the position evaluation results provided by each of the node data processors;
wherein the central coordinator software component processes the ad hoc questions from the user computer by instructing the node coordinator software component to access and process the results of the position evaluations that are stored in the volatile memory of its associated node data processor.

54. The system of claim 53, wherein a node data processor includes a multi-core processor.

55. The system of claim 54, wherein the multi-core processor implements multiprocessing in a single physical package.

56. The system of claim 54, wherein the multi-core processor comprises a dual-core processor, wherein each node coordinator software component is associated with a dual-core processor for managing thread execution on the associated dual-core processor; wherein a thread executes on a core processor of the associated dual-core processor.

57. The system of claim 53, wherein the central coordinator software component comprises a set of instructions for execution on the root data processor and for providing commands to the node coordinator software components.

58. The system of claim 53, wherein the central coordinator software component executing on the root concatenates the results of the position evaluations performed at the node data processors.

59. The system of claim 58, wherein the positions are provided by the user computer.

60. The system of claim 53, wherein the central coordinator software component further processes the ad hoc questions from the user computer by instructing the node coordinator software component the position processing results that are stored in the volatile memory of its associated node data processor.
